(19) United States
(12) Patent Application Publication
(10) Pub. No.: US 2014/0087246 A1
(43) Pub. Date: Mar. 27, 2014

(54) BATTERY

(71) Applicants: Nobuo Yamamoto, Nisshin-shi (JP); Masato Komatsuki, Hashima-gu (JP)

(72) Inventors: Nobuo Yamamoto, Nisshin-shi (JP); Masato Komatsuki, Hashima-gu (JP)

(21) Appl. No.: 14/119,793

(22) PCT Filed: May 25, 2011
(86) PCT No.: PCT/JP2011/062021

§ 371 Date: Nov. 22, 2013

(51) Int. Cl. H01M 2/30

(52) U.S. Cl. CPC H01M 2/30
USPC 429/179

(57) ABSTRACT

A battery includes a battery case obtained by joining first and second case members; an electrode body; electrically conductive terminal members, and an insulation resin member that insulates and seals the terminal members and fixes the terminal members to the first case member. These terminal members have an inside/outside electrically conductive member, which is connected to the electrode body on the inside of the battery case and extends to the outside of the battery case, and an outside electrically conductive member, which is separate from the inside/outside electrically conductive member and is disposed outside the battery case. Moreover, the insulation resin member is formed integrally with the first case member and the inside/outside electrically conductive member.

### CROSS-REFERENCE TO RELATED APPLICATIONS

This application is a national phase application of International Application No. PCT/JP2011/062021, filed May 25, 2011, the content of which is incorporated herein by reference.

### TECHNICAL FIELD

The present invention relates to a cell or battery including a battery case, an electrode body accommodated therein, an electrically-conductive terminal member connected on one side to the electrode body in the battery case and extended on the other side out through the battery case, and an insulating resin member integrally formed with the electrically-conductive terminal member and the battery case to insulate and seal between the electrically-conductive terminal member and the battery case.

### BACKGROUND ART

Heretofore, there is known a cell or battery including a battery case, an electrode body accommodated therein, and an electrically-conductive terminal member connected on one side to the electrode body in the battery case and extended on the other side out through the battery case, and further an insulating resin member separately formed and interposed between the electrically-conductive terminal member and the battery case to insulate and seal therebetween. Furthermore, another cell or battery is known in which an electrically-conductive terminal member is made of a single metal component and an insulating resin member is integrally formed by injection molding using a case lid member of a battery case and an electrically-conductive terminal member. For example, Patent Document 1 discloses such a battery (see claims, FIGS. 1 and 2, and others in Patent Document 1). This battery is advantageous in a small number of components and a small number of work steps.

### RELATED ART DOCUMENTS

### Patent Documents

Patent Document 1: JP-A-2009-104793

### SUMMARY OF INVENTION

### Problems to be Solved by the Invention

Meanwhile, when the area of the electrically-conductive terminal member contacting the insulating resin member is designed to be large in order to enhance the sealing performance between the terminal member and the insulating resin member integral therewith, the terminal member is apt to be complicated in shape. Furthermore, when an out-of-battery connecting terminal (e.g., a crimping terminal attached to a bus bar or a cable) which is a connecting terminal outside a battery is designed to be easily connected to the electrically-conductive terminal member or a contact resistance between the electrically-conductive terminal member and the out-of-battery connecting terminal is set as low as possible, the electrically-conductive terminal member is liable to have a complicated shape.

However, if the electrically-conductive terminal member having such a complicated shape is to be made of a single metal component as mentioned above, the electrically-conductive terminal member itself could not be easily produced. Further, when the electrically-conductive terminal member is inserted in a terminal insertion hole formed in the case lid member prior to injection molding of the insulating resin member, its insertability may be deteriorated, resulting in low productivity. For a conventional battery to be produced in such a manner that the electrically-conductive terminal member made of a single component is used and the insulating resin member is insert molded, it is hard to enhance sealing performance between the electrically-conductive terminal member and the insulating resin member and also difficult to design the electrically-conductive terminal member in an appropriate shape for connection with the out-of-battery connecting terminal.

The present invention has been made in view of the circumstances and has a purpose to provide a cell or battery providing high sealing performance between an electrically-conductive, terminal member and an insulating resin member and also having the electrically-conductive terminal member designed in an appropriate shape for connection with an out-of-battery connecting terminal.

### Means of Solving the Problems

To achieve the above purpose, one aspect of the invention provides a battery including: a battery case formed of a first case member and a second case member joined together; an electrode body accommodated in the battery case; an electrically-conductive terminal member connected on one side to the electrode body in the battery case and extended on the other side out of the battery case through the first case member and to be connected to an out-of-battery connecting terminal which is a connecting terminal outside the battery to form a conductive path between the electrode body and the out-of-battery connecting terminal; and an insulating resin member made of resin to insulate and seal between the electrically-conductive terminal member and the first case member and fix the electrically-conductive terminal member to the first case member, wherein the electrically-conductive terminal member includes: an inside-outside electrically-conductive member connected on one side to the electrode body in the battery case and extended on the other side out of the battery case through the first case member; and an outside electrically-conductive member provided as a separate member from the inside-outside electrically-conductive member, the outside electrically-conductive member being placed outside the battery case and including a base portion connected to the inside-outside electrically-conductive member and an outside connecting portion to which the out-of-battery connecting terminal will be fastened, and the insulating resin member is integrally formed with the first case member and the inside-outside electrically-conductive member.

The above battery can achieve enhanced sealing performance between the electrically-conductive terminal member (the inside-outside electrically-conductive member) and the insulating resin member. Separately from the shape of the inside-outside electrically-conductive member and the sealing performance between the inside-outside electrically-conductive member and the insulating resin member, the electrically-conductive terminal member (the outside electrically-conductive member) can be designed in an appropriate shape for connection with an out-of-battery connecting terminal.

In the above battery, preferably, the inside-outside electrically-conductive member has a surface subjected to a chemical surface treatment to enhance bonding strength with respect to the resin, the insulating resin member is integrally formed with the inside-outside electrically-conductive member subjected to the surface treatment, and the outside electrically-conductive member includes a plated layer on at least a contact surface of the outside connecting portion, with which the out-of-battery connecting terminal will contact.

In the above battery, preferably, the inside-outside electrically-conductive member includes a coating formed on the surface by the surface treatment, the coating being chemically bonded to metal forming the inside-outside electrically-conductive member and also chemically bonded to the resin forming the insulating resin member.

Furthermore, in the above battery, preferably, the coating contains 1,3,5-triazine.

In any one of the above batteries, preferably, the inside-outside electrically-conductive member and the base of the outside electrically-conductive member are joined to each other by welding.

Preferably, any one of the above batteries further includes a bolt placed outside the battery case to fasten the out-of-battery connecting terminal to the outside connecting portion, wherein the outside connecting portion is formed with a screw hole, the bolt includes: a male screw section formed with male threads on an outer periphery and inserted in the screw hole, and a head section having a lager diameter than the male screw section and being engageable with the outside connecting portion, and the insulating resin member holds the head section of the bolt to disable rotation of the head section about an axis.

In any one of the above batteries, preferably, the outside electrically-conductive member is made of a metal plate and bent in a thickness direction to provide the base portion, the outside connecting portion, and a rising portion connecting them, arranged in a crank shape so that, the base portion is extended along a perforated surface of the first case member through which the inside-outside electrically-conductive member passes, the rising portion is bent at an end of the base portion and vertically extended therefrom in a direction apart from the first case member, and the outside connecting portion is bent at an end of the rising portion and extended in parallel to the base portion.

### BRIEF DESCRIPTION OF THE DRAWINGS

FIG. 1 is a longitudinal sectional view showing a lithium ion secondary battery in a first embodiment;

FIG. 2 is a perspective view showing an electrode body in the first embodiment;

FIG. 3 is a partial plan view showing a state where a positive electrode sheet and a negative electrode sheet are laminated by interposing separators therebetween in the first embodiment;

FIG. 4 is a partial longitudinal sectional view showing a case lid member, an electrically-conductive terminal member, a bolt, and an insulating resin member in the first embodiment;

FIG. 5 is a plan view of the case lid member, electrically-conductive terminal member, bolt, and insulating resin member in the first embodiment, seen from above in FIG. 4;

FIG. 6 is a longitudinal sectional view showing an outside electrically-conductive member in the first embodiment;

FIG. 7 is a plan view of the outside electrically-conductive member in the first embodiment, seen from above in FIG. 6;

FIG. 8 is a longitudinal sectional view showing an inside-outside electrically-conductive member in the first embodiment;

FIG. 9 is a plan view of the inside-outside electrically-conductive member in the first embodiment, seen from above in FIG. 8;

FIG. 10 is a partial plan view of the case lid member, around a terminal hole, in the first embodiment;

FIG. 11 is a longitudinal sectional view showing a method of producing a lithium ion secondary battery in the first embodiment, showing a state where an insulating resin member is integrally made of resin by injection molding to unitize the case lid member and the inside-outside electrically-conductive member;

FIG. 12 is a plan view showing the method of producing a lithium ion secondary battery in the first embodiment, showing a state where the case lid member, electrically-conductive terminal member, and insulating resin member, seen from above in FIG. 11;

FIG. 13 is a partial longitudinal view showing a case lid member, an electrically-conductive terminal member, a bolt, and an insulating resin member in a second embodiment;

FIG. 14 is a plan view of the case lid member, electrically-conductive terminal member, bolt, and insulating resin member in the second embodiment, seen from above in FIG. 13;

FIG. 15 is a longitudinal sectional view of an inside-outside electrically-conductive member in the second embodiment;

FIG. 16 is a longitudinal sectional view showing a method of producing a lithium ion secondary battery in the second embodiment, showing a state where an insulating resin member is integrally made of resin by injection molding to unitize the case lid member and the inside-outside electrically-conductive member;

FIG. 17 is a plan view showing the method of producing a lithium ion secondary battery in the second embodiment, showing a state where the case lid member, electrically-conductive terminal member, and insulating resin member, seen from above in FIG. 16;

FIG. 18 is a partial longitudinal sectional view showing a case lid member, an electrically-conductive terminal member, a bolt, and an insulating resin member in a third embodiment,

FIG. 19 is a plan view of the case lid member, electrically-conductive terminal member, bolt, and insulating resin member in the third embodiment, seen from above in FIG. 18;

FIG. 20 is a longitudinal sectional view of an outside electrically-conductive member in the third embodiment;

FIG. 21 is a plan view of the outside electrically-conductive member in the third embodiment, seen from above in FIG. 20;

FIG. 22 is a longitudinal sectional view of an inside-outside electrically-conductive member in the third embodiment;

FIG. 23 is a plan view of the inside-outside electrically-conductive member of FIG. 22 in the third embodiment, seen from above;

FIG. 24 is a longitudinal sectional view showing a method of producing a lithium ion secondary battery in the third embodiment, showing a state where an insulating resin member is integrally made of resin by injection molding to unitize the case lid member and the inside-outside electrically-conductive member;

FIG. 25 is a plan view showing the method of producing a lithium ion secondary battery in the third embodiment, showing a state where the case lid member, electrically-conductive terminal member, and insulating resin a ember, seen from above in FIG. 24;

FIG. 26 is a partial longitudinal sectional view showing a case lid member, an electrically-conductive terminal member, a bolt, and an insulating resin member in a fourth embodiment;

FIG. 27 is a plan view of the case lid member, electrically-conductive terminal member, bolt, and insulating resin member in the fourth embodiment, seen from above in FIG. 26;

FIG. 28 is a longitudinal sectional view of an outside electrically-conductive member in the fourth embodiment;

FIG. 29 is a plan view of the outside electrically-conductive member in the fourth embodiment, seen from above in FIG. 28;

FIG. 30 is a longitudinal sectional view showing a method of producing a lithium ion secondary battery in the fourth embodiment, showing a state where an insulating resin member is integrally made of resin by injection molding to unitize the case lid member and the inside-outside electrically-conductive member;

FIG. 31 is a plan view showing the method of producing a lithium ion secondary battery in the fourth embodiment, showing a state where the case lid member, electrically-conductive terminal member, and insulating resin member, seen from above in FIG. 30;

FIG. 32 is an explanatory view showing a vehicle in a fifth embodiment; and

FIG. 33 is an explanatory view showing a hammer drill in a sixth embodiment.

### REFERENCE SIGNS LIST

100, 200, 300, 400 Lithium ion secondary battery (Battery)
110 Battery case
111 Case main member (Second case member)
113 Case lid member (First case member)
113c Surface (of case lid member)
113ca Upper surface (Perforated surface) (of case lid member)
113cg Lower surface (Perforated surface) (of case lid member)
113h Terminal insertion hole
114 Coating
120 Electrode body
150, 250, 350, 450 Positive electrically-conductive terminal member (Electrically-conductive terminal member)
160, 260, 360, 460 Negative electrically-conductive terminal member (Electrically-conductive terminal member)
151, 251, 351 inside-outside electrically-conductive member
151c, 251c, 351c Surface (of inside-outside electrically-conductive member)
151gy Weld portion
251fy, 351fy Weld portion
152, 352 Coating
153, 353 Outside electrically-conductive member
153e, 353e Base portion
153eh, 353eh Fixing hole
153f, 353f Rising portion
153g, 353g Outside connecting portion
153gh, 353gh Screw insertion hole
153gc, 353gc Contact surface
154, 354 Plated layer
155 Bolt
155e Male screw section
155f Head section
170, 370 Insulating resin member
700 Hybrid car (Vehicle)
800 Hammer drill (Battery using device)
BX Axis (of bolt)
GT Bus bar (Out-of-battery connecting terminal)

### MODE FOR CARRYING OUT THE INVENTION

### First Embodiment

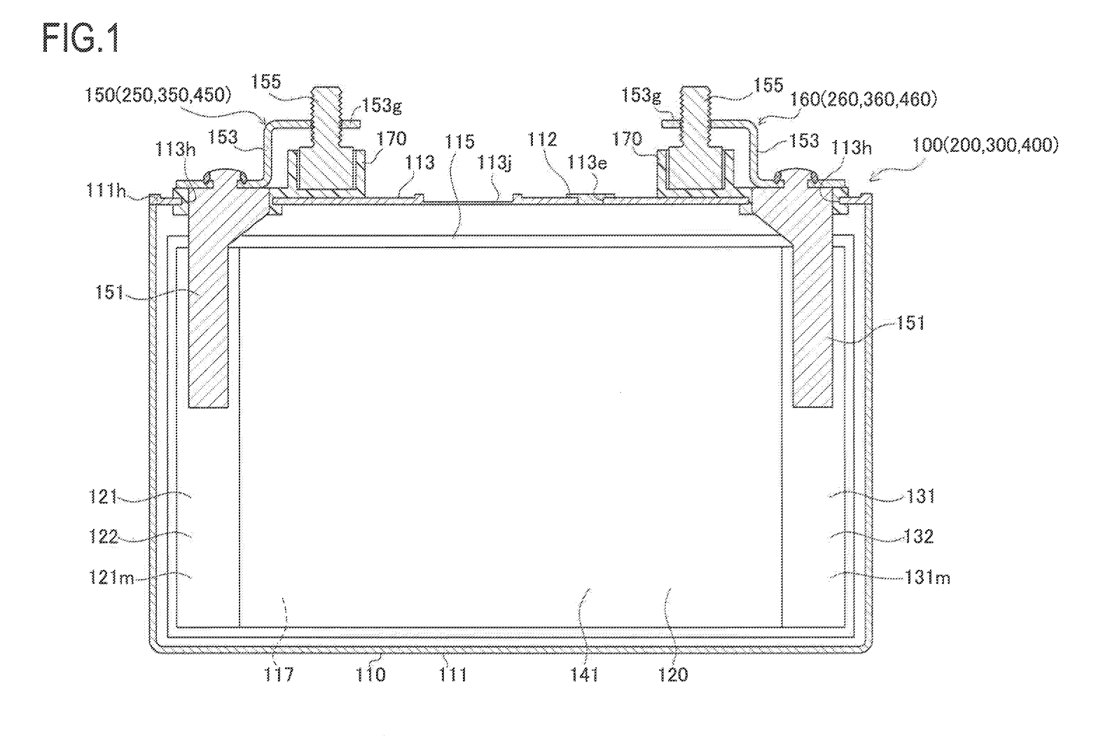

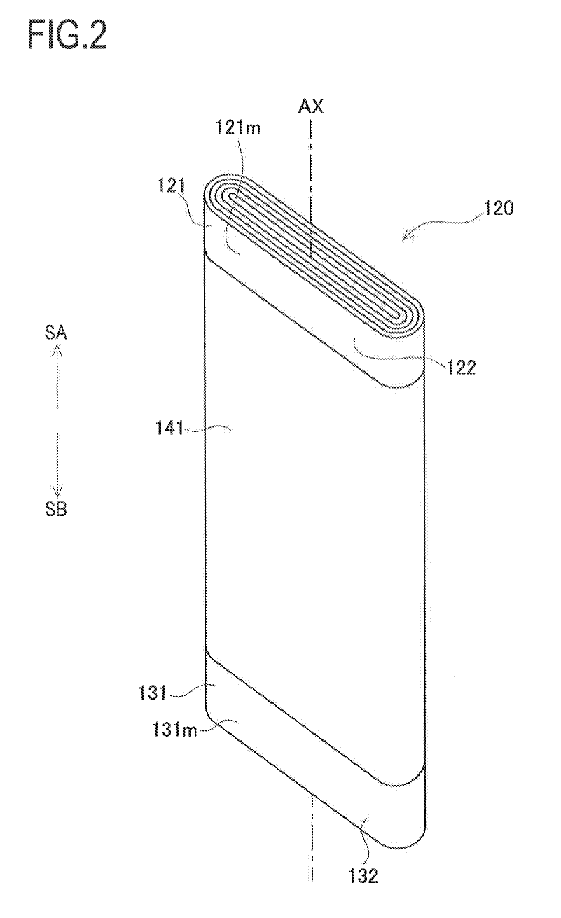

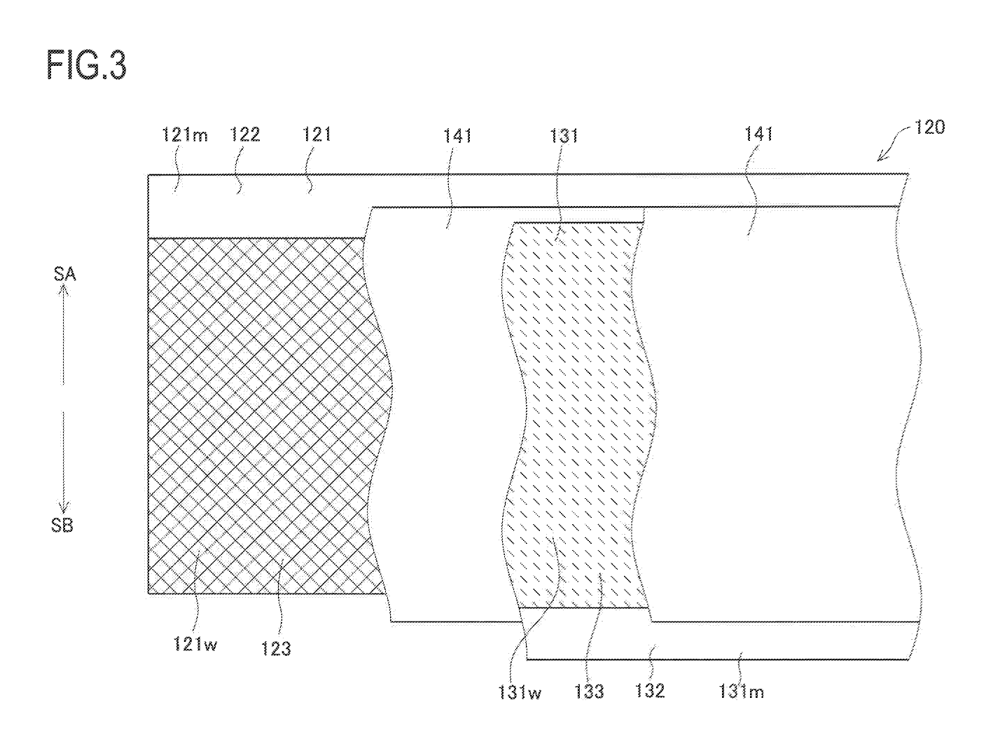

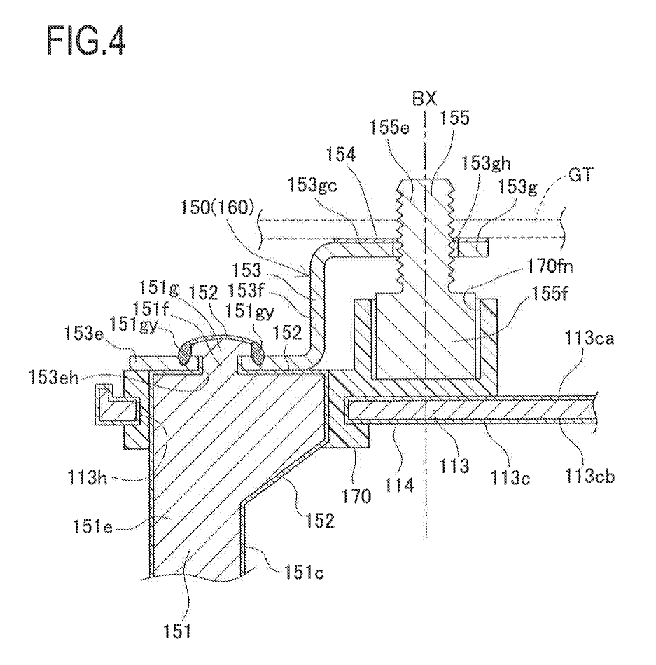

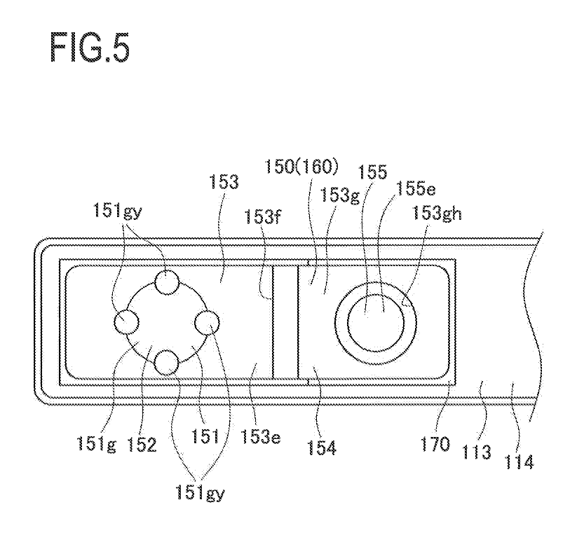

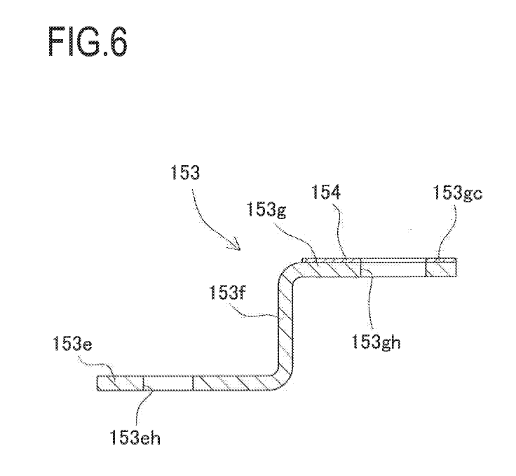

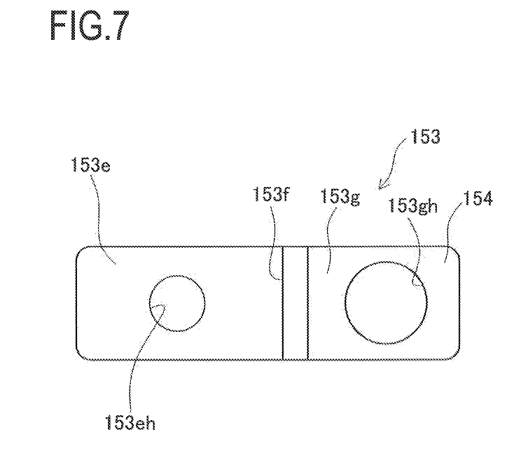

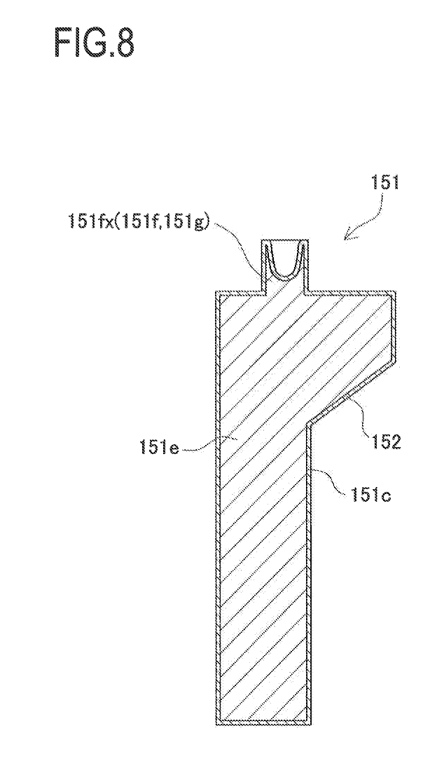

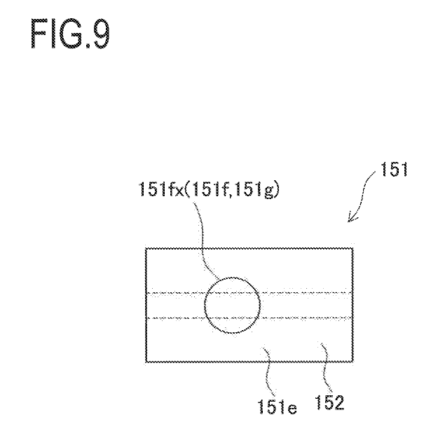

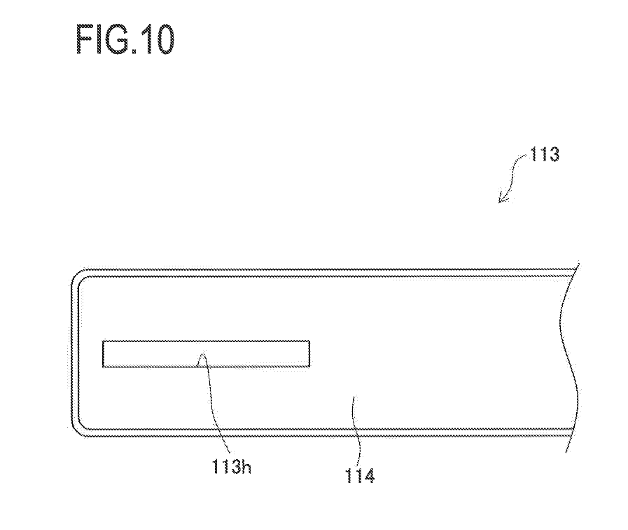

A detailed description of a preferred embodiment of the present invention will now be given referring to the accompanying drawings. FIG. 1 shows a lithium ion secondary battery (“battery”) 100 (hereinafter, also simply referred to as a battery 100) in the first embodiment. FIG. 2 shows a state where a wound-type electrode body 120 forming the battery 100 and FIG. 3 shows an unwound state thereof. FIGS. 4 and 5 illustrate in detail a case lid member 113, an electrically-conductive terminal member 150 or 160, a bolt 155, and an insulating resin member 170. FIGS. 6 and 7 show an outside electrically-conductive member 153. FIGS. 8 and 9 show an inside-outside electrically-conductive member 151 and FIG. 10 shows a part of the case lid member 113, around a terminal insertion hole 113h. The following explanation is made assuming that an upper side in FIGS. 1-4 is an upper side of the battery 100 and a lower side is a lower side of the battery 100.

The battery 100 is a rectangular battery to be mounted in a vehicle such as a hybrid car and an electric car or in a battery using device such as a hammer drill. This battery 100 includes a rectangular battery case 110, a wound-type electrode body 120 accommodated in this battery case 110, electrically-conductive terminal members (a positive electrically-conductive terminal member 150 and a negative electrically-conductive terminal member 160) supported in the battery case 110, insulating resin members 170 that insulate and seal between the battery case 110 and the corresponding electrically-conductive terminal members 150 and 160, and others. Furthermore, this battery 100 includes bolts 155 to fasten an out-of-battery connecting terminal such as a bus bar GT illustrated by a broken line in FIG. 4 and a crimp-type terminal attached to a tip of a cable to the electrically-conductive terminal members 150 and 160. In the battery case 110, a non-aqueous type electrolyte 117 is contained.

The battery case 110 is made of metal (aluminum in the first embodiment). This battery case 110 consists of a box-shaped main member (a second case member) 111 opening only in an upper side and a rectangular plate-shaped case lid member (a first case member) 113 joined (concretely, welded) to close an opening 111h of the case body member 111 (see FIGS. 1 and 10).

The case lid member 113 is provided with a safety valve 113j (see FIG. 1) that will be torn when the inner pressure of the battery case 110 reaches a predetermined value. This case lid member 113 is provided with a liquid inlet 113e which is sealingly closed by a seal member 112. Furthermore, the case lid 113 is formed, near both ends in its longitudinal direction (a right and left direction in FIGS. 1, 4, and 10), with terminal insertion holes 113h having a rectangular shape in plan view and penetrating through the case lid member 113 (opening at an upper surface 113ca and a lower surface 113cb). In one of the terminal insertion holes 113h (a left one in FIG. 1), the positive electrically-conductive terminal member 150 mentioned later is inserted. In the other hole 113h (a right one in FIG. 1), the negative electrically-conductive terminal member 160 mentioned later is inserted.

The entire surface 113c of the case lid member 113 is subjected to a chemical surface treatment to enhance bonding strength with resin (PPS (polyphenylene sulfide) in the first embodiment) forming the insulating resin member 170 mentioned later. To be concrete, the surface 113c of the case lid member 113 is coated with a coating 114 by a TRI treatment described later. This coating 114 is an oxide film that is mainly made of alumina and contains 1,3,5-triazine. The coating 114 is chemically bonded to the metal (aluminum in the first embodiment) forming the case lid member 113 and also chemically bonded to the insulating resin member 170 through a contact (joint) portion with the insulating resin member 170. Therefore, the case lid member 113 and the insulating resin member 170 can achieve enhanced bonding strength between their contact portions and sealing performance therebetween.

Next, the electrode body 120 will be explained. This electrode body 120 is enclosed in an insulating film envelop 115 made from an insulating film and shaped like a bag opening only on an upper side, and then is accommodated in a sideways position in the battery case 110 (see FIG. 1). This electrode body 120 consists of a strip-shaped positive electrode sheet 121 and a strip-shaped negative electrode sheet 131 that are overlaid or laminated by interposing strip-shaped separators 141 (see FIG. 3) therebetween and wound together around an axis AX and compressed into a flattened shape (see FIG. 2).

The positive electrode sheet 121 has, a core material, a positive current collector foil 122 made of a strip-shaped aluminum foil. On each main surface of this foil 122, a positive electrode active material layer 123 is provided in a strip shape in the longitudinal direction (a right and left direction in FIG. 3) in a region corresponding to a partial area in a width direction and extending in the longitudinal direction. These positive electrode active material layers 123 are made of a positive electrode active material, a conductive agent, and a binder.

A strip-shaped portion of the positive electrode sheet 121, in which the positive current collector foil 122 and the positive electrode active material layers 123 are present in the thickness direction is referred to as a positive electrode part 121w. This positive electrode part 121w in a finished state of the electrode body 120 faces a negative electrode part 131w mentioned later of the negative electrode sheet 131 through the separator 141 over the entire region (see FIG. 3). In association with the presence of the positive electrode part 121w in the positive electrode sheet 121, one end portion (an upper end in FIG. 3) in the width direction of the positive current collector foil 122 extends in a strip shape in the longitudinal direction, forming a positive current collector part 121m in which the positive electrode active material layers 123 are not provided in the thickness direction. A part of this positive current collector part 121m in the width direction protrudes, in a spiral form, from the separators 141 on one side SA in the direction of the axis AX and is connected to the positive electrically-conductive terminal member 150 described later (see FIG. 1).

On the other hand, the negative electrode sheet 131 includes, as a core material, a negative current collector foil 132 made of a strip-shaped copper foil. On each main surface of this foil 132, a negative electrode active material layer 133 is provided in a strip shape in the longitudinal direction (the right and left direction in FIG. 3) in a region corresponding to a partial area in a width direction and extending in the longitudinal direction. These negative electrode active material layers 133 are made of a negative electrode active material, a binder, and a thickening agent.

A strip-shaped portion of the negative electrode sheet 131, in which the negative current collector foil 132 and the negative electrode active material layers 133 are present in the thickness direction is referred to as a negative electrode part 131w. This negative electrode part 131w in a finished state of the electrode body 120 faces the separator 141 over the entire region. In association with the presence of the negative electrode part 131w in the negative electrode sheet 131, one end portion (a lower end in FIG. 3) in the width direction of the negative current collector foil 132 extends in a strip shape in the longitudinal direction, forming a negative current collector part 131m in which the negative electrode active material layers 133 are not provided in the thickness direction. A part of this negative current collector part 131m in the width direction protrudes, in a spiral form, from the separators 141 on the other side SB in the direction of the axis AX and is connected to the negative electrically-conductive terminal member 160 described later (see FIG. 1).

Each of the separators 141 is a porous film made of resin, concretely, polypropylene (PP) and polyethylene (PE), formed in a strip shape.

Next, the electrically-conductive terminal members (the positive electrically-conductive terminal member 150 and the negative electrically-conductive terminal member 160) will be explained (see FIGS. 1, 4 to 9). The positive electrically-conductive terminal member 150 and the negative electrically-conductive terminal member 160 are basically identical in structure. Thus, their constituent components are explained with the common reference signs between the positive electrically-conductive terminal member 150 and the negative electrically-conductive terminal member 160.

The electrically-conductive terminal members 150 and 160 are configured to link the electrode body 120 to the out-of-battery connecting terminal (the bus bar GT and so on) to be connected to the battery 100 to provide a current path to supply current therebetween. To be specific, the positive electrically-conductive terminal member 150 is connected on one side to the positive current collector part 121m of the electrode body 120 in the battery case 110 as described above and extends on the other side out of the battery case 110 (above the case lid member 113) by passing through the battery case 110 (the case lid member 113) (through the terminal insertion hole 113h). The negative electrically-conductive terminal member 160 is connected on one side to the negative current collector part 131m of the electrode body 120 in the battery case 110 as described above and extends on the other side out of the battery case 110 (above the case lid member 113) by passing through the battery case 110 (through the terminal insertion hole 113h).

Each of the above electrically-conductive terminal members 150 and 160 consists of an inside-outside electrically-conductive member 151 and an outside electrically-conductive member 153 which are separate components. The inside-outside electrically-conductive member 151 connects the electrode body 120 to the outside electrically-conductive member 153 to provide a current path to supply current therebetween. The positive electrically-conductive terminal member 150 (the inside-outside electrically-conductive member 151 and the outside electrically-conductive member 153 for positive electrode) is made of aluminum in consideration of welding with the positive current collector foil 122 (an aluminum foil) of the electrode body 120. On the other hand, the negative electrically-conductive terminal member 160 (the inside-outside electrically-conductive member 151 and the outside electrically-conductive member 153 for negative electrode) is made of copper in consideration of welding with the negative current collector foil 132 (a copper foil) of the electrode body 120.

The inside-outside electrically-conductive member 151 includes a body portion 151e, an insertion portion 151f, and a caulking portion 151g. The body portion 151e is placed in the battery case 110 and connected (welded) to the electrode body 120 (the positive current collector part 121 in or the negative current collector part 131m), while passing through the insulating resin member 170 described later and extending above the case lid member 113 through the terminal insertion hole 113h.

The insertion portion 151f has a columnar shape located between and continuous to the body portion 151e and the caulking portion 151g. This insertion portion 151f is inserted in a fixing hole 153eh of a base portion 153e of the outside electrically-conductive member 153 described later.

The caulking portion 151g is caulked, or deformed, and widened in diameter like an umbrella so as to contact from above with the base portion 153e of the outside electrically-conductive member 153 mentioned later and also connected to the base portion 153e through weld portions 151gy formed at four spots arranged in a circumferential direction. In the inside-outside electrically-conductive member 151 shown in FIGS. 8 and 9, an unprocessed insertion portion 151a which is not deformed yet into the caulking portion 151g is illustrated.

This inside-outside electrically-conductive member 151 is subjected, over the entire surface 151c, to a chemical surface treatment to enhance bonding strength with the resin (PPS in the first embodiment) forming the insulating resin member 170 mentioned later. To be concrete, on the surface 151c of the inside-outside electrically-conductive member 151 is formed with a coating 152 by a TRI treatment mentioned later. In the inside-outside electrically-conductive member 151 made of aluminum for positive electrode, the coating 152 is a film made of alumina and containing 1,3,5-triazine, which is chemically bonded to the metal (aluminum) forming the inside-outside electrically-conductive member 151 and also chemically bonded to the resin forming the insulating resin member 170 through a contact (joint) portion with the insulating resin member 170. In the inside-outside electrically-conductive member 151 made of copper for negative electrode, this coating 152 is a film containing 1,3,5-triazine, which is chemically bonded to the metal (copper) forming the inside-outside electrically-conductive member 151 and also chemically bonded to the resin forming the insulating resin member 170 through a contact (joint) portion with the insulating resin member 170. Accordingly, in each of the positive electrode and the negative electrode, the inside-outside electrically-conductive member 151 and the insulating resin member 170 can achieve high bonding strength between their contact portions and high sealing performance therebetween.

The outside electrically-conductive member 153 is a metal plate bent in its thickness direction, i.e., in a crank shape (Z-like shape), including the base portion 153e, a rising portion 153f, and an outside connecting portion 153g. This outside electrically-conductive member 153 is placed outside the battery case 110 (i.e., on the case lid member 113). The base portion 153e has a rectangular plate shape extending along the case lid member 113 and fixed thereto through the insulating resin member 170 mentioned later. This base portion 153e is formed with a circular fixing hole 153eh penetrated through the base portion 153e, in which the insertion portion 151f of the inside-outside electrically-conductive member 151 is inserted as described above. To this base portion 153e, furthermore, the caulking portion 151g of the inside-outside electrically-conductive member 151 is joined by the welded portions 151gy as explained above.

The rising portion 153f has a rectangular plate shape, which is bent at the end of the base portion 153e and vertically extended therefrom in a direction apart from the case lid member 113.

The outside connecting portion 153g has a plate shape, which is bent at the end of the rising portion 153f and extended in parallel to the base portion 153e. This outside connecting portion 153g is formed with a screw hole 153g through which a male screw section 155e of a bolt 155 mentioned later is inserted and with which a head section 155f of the bolt 155 mentioned later engages. This outside connecting portion 153g is also to be connected to the out-of-battery connecting terminal such as the bus bar GT (see FIG. 4).

Of the outside connecting portion 153g, a contact surface 153gc which the out-of-battery connecting terminal such as the bus bar GT is to be placed in contact with is formed with a plated layer 154 having a thickness of 4 μm. This plated layer 154 is made of a metal, e.g. tin plating, having high (good) oxidation resistance than the metal (aluminum or copper in the first embodiment) forming the outside connecting portion 153g. Therefore, the contact surface 153gc of the outside connecting portion 153g is resistant to oxidation. Since the tin is a relatively soft metal, furthermore, this enables good connection (contact) between the plated layer 154 and the out-of-battery connecting terminal such as the bus bar GT. Accordingly, contact resistance can be reduced between the outside connecting portion 153g and the out-of-battery connecting terminal such as the bus bar GT.

Next, the bolts 155 will be explained (see FIGS. 1, 4, and 5). Each bolt 155 is a fastening member to fasten the out-of-battery connecting terminal (e.g., the bus bar GT) to the electrically-conductive terminal member 150 or 160 as explained above. The bolts 155 are placed on the case lid member 113 so that the bolts 155 are connected (contacted) with the corresponding outside connecting portion 153g when the out-of-battery connecting terminal such as the bus bar GT is fastened by a nut or the like to the outside connecting portions 153g of the outside electrically-conductive members 153 of the electrically-conductive terminal members 150 and 160. Each bolt 155 has the male screw section 155e formed with male threads on its outer periphery and the head section 155E having a larger diameter than the male screw section 155e.

The male screw section 155e is inserted in the screw hole 153h of the outside connecting portion 153g and extends in a direction perpendicular to the case lid member 113 (in a vertical direction). Further, the head section 155f has a hexagonal shape and is placed close to the case lid member 113 side (a lower side) than the outside connecting portion 153g. The head section 155f is fitted and held in the insulating resin member 170 (a recess 170fn for the head section) mentioned later.

Next, the insulating resin members 170 will be explained (see FIGS. 1, 4, and 5). Each insulating resin member 170 is made of PPS (polyphenylene sulfide) by injection molding as mentioned later integral with the case lid member 113 and the inside-outside electrically-conductive member 151. Each insulating resin member 170 is located outside the battery case 110 (on the case lid member 113), inside the terminal insertion hole 113h of the case lid member 113, and also inside the battery case 110, thereby providing insulation between the electrically-conductive terminal member 150 or 160 and the case lid member 113 and also fixing the electrically-conductive terminal members 150 and 160 to the case lid member 113 while sealing therebetween.

As explained above, the surface 113c of the case lid member 113 is formed with the coating 114 by the TRI treatment mentioned later. The surface 151c of each inside-outside electrically-conductive member 151 is also formed with the coating 152 by the TRI treatment. These coatings 114 and 152 are chemically bonded to the metal (aluminum or copper in the first embodiment) forming the case lid member 113 or the inside-outside electrically-conductive member 151 and also chemically bonded to the resin (PPS in the first embodiment) forming the insulating resin member 170. This achieves high bonding strength between the contact portions (joint portions) of the case lid member 113 and the insulating resin member 170 and high bonding strength between the contact portions (joint portions) of the inside-outside electrically-conductive member 151 and the insulating resin member 170, and also provides high sealing performance therebetween.

The insulating resin member 170 holds the head section 155f of the bolt 155 while insulating between the head section 155f of the holt 155 and the case lid member 113. Specifically, the head section 155f of the bolt 155 is fitted (loosely fitted) with a clearance in the recess 170fn hexagonal in plan view provided in the insulating resin member 170, so that the head section 155f of the bolt 155 is held in the insulating resin member 170. Accordingly, the bolt 155 is enabled to move in a direction of an axis BX but disabled to rotate about the axis BX. Thus, when the bus bar GT is fastened with a nut or the like to the outside connecting portions 153g of the electrically-conductive terminal members 150 and 160, the bolts 155 are moved toward a leading end (an upper side) in the axis BX direction, making the head section 155f abut on the outside connecting portion 153g.

As explained above, the battery 100 in the first embodiment includes the battery case 110 formed from the first case member (the case lid member) 113 and the second case member (the case body member) 111, the electrode body 120 accommodated in the battery case 110, and the electrically-conductive terminal members 150 and 160 each of which is connected on one side to the electrode body 120 inside the battery case 110 and is extended on the other side out of the battery case 110 through the first case member 113 to connect with the out-of-battery connecting terminal GT which is an out-of-battery connecting terminal to form a conductive path between the electrode body 120 and the out-of-battery connecting terminal GT. The battery 100 further includes the insulating resin members 170 made of resin to insulate between the electrically-conductive terminal members 150 and 160 and the first case member 113 and configured to fix the electrically-conductive terminal members 150 and 160 to the first case member 113.

Each of the electrically-conductive terminal members 150 and 160 includes the inside-outside electrically-conductive member 151 connected on one side to the electrode body 120 inside the battery case 110 and extended on the other side out of the battery case 110 through the first case member 113, and the outside electrically-conductive member 153 configured as a separate member from the inside-outside electrically-conductive member 151, the outside electrically-conductive member 153 including the base portion 153e placed outside the battery case 110 and connected to the inside-outside electrically-conductive member 151, and the outside connecting portion 153g to which the out-of-battery connecting terminal (the bus bar (IT) will be fastened. The insulating resin members 170 are integrally formed with the first case member 113 and the corresponding inside-outside electrically-conductive members 151.

Each of the electrically-conductive terminal members 150 and 160 of the battery 100 includes the inside-outside electrically-conductive member 151 and the outside electrically-conductive member 153 which are separate components, and only the inside-outside electrically-conductive member 151 is formed integral with the insulating resin member 170 and others. Therefore, even when the inside-outside electrically-conductive member 151 is configured to increase the sealing performance, for example, to increase the contact area between the electrically-conductive terminal member 150 or 160 (the inside-outside electrically-conductive member 151) and the insulating resin member 170, this configuration does not decrease the productivity of the battery 100 as explained later and can enhance the sealing performance between the electrically-conductive terminal member 150 or 160 (the inside-outside electrically-conductive member 151) and the insulating resin member 170. The shape of the outside electrically-conductive member 153 can be determined separately from the shape of the inside-outside electrically-conductive member 151 and the sealing performance between the inside-outside electrically-conductive member 151 and the insulating resin member 170. Thus, the electrically-conductive terminal members 150 and 160 can be designed in an appropriate shape for connection with the out-of-battery connecting terminal (the bus bar GT or the like).

In the first embodiment, furthermore, the inside-outside electrically-conductive members 151 are subjected to a chemical surface treatment to enhance the bonding strength between the surfaces 151c with the resin forming the insulating resin members 170. The insulating resin members 170 are integrally formed with the corresponding inside-outside electrically-conductive members 151 having been subjected to the surface treatment. Furthermore, in the outside electrically-conductive members 153, at least the contact surfaces 153gc of the outside connecting portions 153g with which the out-of-battery connecting terminal (the bus bar GT) will contact are formed with the plated layers 154.

In the above battery 100, of the electrically-conductive terminal members 150 and 160, the surfaces 151c of the inside-outside electrically-conductive members 151 are subjected to the chemical surface treatment so that the surface-treated inside-outside electrically-conductive members 151 are integrally formed with the insulating resin members 170. Accordingly, the bonding strength between the contact portions (joint portions) of the electrically-conductive terminal members 150 and 160 (the inside-outside electrically-conductive members 151) and the insulating resin members 170 can be increased, and therefore the sealing performance therebetween can be especially enhanced. On the other hand, in the outside connecting portions 153g of the outside electrically-conductive member 153, the contact surfaces 153gc which will contact with the out-of-battery connecting terminal such as the has bar CT is formed with the plated layers 154 for preventing oxidation. This can reduce contact resistance with the out-of-battery connecting terminal such as the bus bar GT.

In addition, the outside electrically-conductive members 153 are separate components from the inside-outside electrically-conductive members 151 and thus do not need to be subjected to the surface treatment as mentioned later. Accordingly, it is possible to avoid deficiencies such as peel-off of the plated layers 154 which may be caused in the surface treatment if performed after formation of the plated layers 154. It is also possible to prevent difficulties in forming the plated layers 154 or avoid an increase in resistance of the contact surfaces 153gc of the outside connecting portions 153g, which may be caused in the surface treatment if performed before formation of the plated layers 154. In this battery 100, accordingly, the sealing performance between each of the electrically-conductive terminal members 150 and 160 and corresponding one of the insulating resin members 170 can be enhanced and also the contact resistance between the electrically-conductive terminal members 150 and 160 and the bus bar GT and others can be reduced.

In the first embodiment, therefore, the inside-outside electrically-conductive members 151 are subjected to the surface treatment whereby forming the coatings 152 on the surfaces 151c, the coatings 152 being chemically bonded to the metal forming the inside-outside electrically-conductive members 151 and chemically bonded to the resin forming the insulating resin members 170. Since the coatings 152 are interposed between the inside-outside electrically-conductive members 151 and the insulating resin members 170, the bonding strength between each of the inside-outside electrically-conductive members 151 and corresponding one of the insulating resin members 170 can be especially enhanced, thus increasing the sealing performance therebetween.

In the first embodiment, furthermore, each coating 152 includes 1,3,5-triazine. This 1,3,5-triazine is chemically bonded to the metal forming each inside-outside electrically-conductive member 151 directly or indirectly through a functional group and others and also chemically bonded to the resin forming each insulating resin member 170. This can especially enhance the bonding strength between the inside-outside electrically-conductive members 151 and the insulating resin members 170, thereby particularly increasing the sealing performance therebetween.

In the first embodiment, furthermore, each of the inside-outside electrically-conductive members 151 and corresponding one of the base portions 153e of the outside electrically-conductive members 153 are connected to each other by welding. Thus, the resistance in the connecting portions of the inside-outside electrically-conductive members 151 and the outside electrically-conductive members 153 can be reduced. For example, when the bus bar GT or the like is to be fastened with a nut or the like to the outside connecting portion 153g of the outside electrically-conductive member 153, even if a large external three is applied on the outside electrically-conductive member 153, the connecting portions of the inside-outside electrically-conductive member 151 and the outside electrically-conductive member 153 is less likely to be broken. This can achieve high connecting reliability between the inside-outside electrically-conductive member 151 and the outside electrically-conductive member 153.

In the battery 100 in the first embodiment, furthermore, there are provided the bolts 155 placed outside the battery case 110 to fasten the out-of-battery connecting terminal (the bus bar GT) to the outside connecting portions 153g. Further, the outside connecting portions 153g are each formed with one screw hole 153gh. Each bolt 155 includes the male screw section 155e formed with male threads on its outer periphery and inserted in the screw holes 153gh and the head section 155f having a larger diameter than the male screw section 155e and being engageable with the outside connecting portion 153g. This insulating resin member 170 holds the head section 155f of the bolt 155 to disable rotation of the head section 155f about the axis BX.

Since the battery 100 includes the bolts 155, the out-of-battery connecting terminal such as the bus bar GT can be easily fastened to the outside connecting portions 153g by use of a nut or the like. At the time of fastening, the rotation of each bolt 155 about the axis BX is disabled. Thus, the bus bar GT or the like can be reliably connected to the outside connecting portions 153g. The insulating resin members 170 serve to restrict the rotation of the bolts 155 about the axis BX, so that the structure is simple and the number of components is reduced. In the first embodiment in which the bolts 155 are movable in the axis BX direction, the bus bar GT or the like can be reliably connected (fastened) to the outside connecting portions 153g.

In the first embodiment, moreover, each outside electrically-conductive member 153 is formed from a metal plate bent in the thickness direction, forming the base portion 153e, the outside connecting portion 153g, and the rising portion 153f connecting them, in a crank shape. Specifically, the base portion 153e is extended along the perforated surfaces (upper and lower surfaces) 113ca and 113cb of the first case member 113, through which the inside-outside electrically-conductive member 151 passes, the rising portion 153f is bent at the end of the base portion 153e and vertically extended therefrom in the direction apart from the first case member 113, and the outside connecting portion 153g is bent at the end of the rising portion 153f and is extended in parallel to the base portion 153e.

With the outside electrically-conductive members 153 configured as above, the outside connecting portions 153g are placed in a position parallel to the upper surface 113ca and the lower surface 113cb of the case lid member 113 and also apart from the case lid member 113. Accordingly, the out-of-battery connecting terminal such as the bus bar GT can be easily connected to the outside connecting portions 153g.

A method for producing the above battery 100 will be explained below. The strip-shaped positive electrode sheet 121 and the strip-shaped negative electrode sheet 131, separately produced, are firstly laminated one on the other by interposing the strip-shaped separators 141 therebetween (see FIG. 3) and wound together about the axis AX by use of a winding core. Thereafter, this wound assembly is compressed into a flattened shape, forming the electrode body 120 (see FIG. 2).

The case lid member 113 and the inside-outside electrically-conductive member 151 are prepared (see FIGS. 8-10). In the first embodiment, as described above, each of the electrically-conductive terminal members 150 and 160 consists of two separate components, i.e., the inside-outside electrically-conductive member 151 and the outside electrically-conductive member 153. Thus, the inside-outside electrically-conductive members 151 can be easily formed (processed). The case lid member 113 and the inside-outside electrically-conductive members 151 are separately subjected to the chemical surface treatment (the TRI treatment in the first embodiment) to enhance the bonding strength with the resin (PPS in the first embodiment) forming the insulating resin members 170.

To be specific, the case lid member 113 and the inside-outside electrically-conductive member 151 for positive electrode, both made of aluminum, are first immersed in an alkali aqueous solution such as sodium hydrate, thereby alkali etching the surface 113c of the case lid member 113 and the surface 151c of the inside-outside electrically-conductive member 151, as disclosed in for example JP 2009-144198A. Then, these members 113 and 115 are immersed in an acid aqueous solution such as sulfuric acid to perform acid treatment (neutralizing treatment).

Thereafter, the above members 113 and 151 are immersed in an electrolyte aqueous solution containing triazine compound (1,3,5-triazine-2,4,6-trithiol-monosodium in the first embodiment) and including sulfuric acid. Further, a platinum plate is immersed in this electrolyte aqueous solution. An electro deposition process is performed by applying voltage between the above members 131 and 151 as an anode and the platinum plate as a cathode.

Accordingly, the coating 114 containing alumina as a main component and 1,3,5-triazine is formed on the surface 113c of the case lid member 113. This coating 114 is chemically bonded to the aluminum forming the case lid member 113. Similarly, the coating 152 containing alumina as a main component and 1,3,5-triazine is formed on the surface 151c of the inside-outside electrically-conductive member 151. This coating 152 is chemically bonded to the aluminum forming the electrically-conductive member 151. Thereafter, those members 113 and 151 are washed with water.

For the inside-outside electrically-conductive member 151 for negative electrode, made of copper, this electrically-conductive member 151 is first washed as disclosed in JP 382318913. Then, this member 151 is immersed in a solution containing triazine compound (1,3,5-triazine-2,4,6-trithiol-monosodium in the first embodiment). Accordingly, a coating containing 1,3,5-triazine is formed on the surface 151c of the electrically-conductive member 151. This coating is chemically bonded to the copper forming the electrically-conductive member 151.

Thereafter, the inside-outside electrically-conductive member 151 made of copper is immersed in for example an ethanol solution of 1,10-diamino decane, causing reaction (or adsorbtion) of 1,10-diamino decane with the above coating, so that the coating can maintain the reaction property for a long period. As above, the coating 152 including 1,3,5-triazine and being chemically bonded to the copper forming the inside-outside electrically-conductive member 151 is formed on the surface 151c of the electrically-conductive member 151.

Successively, the case lid member 113 and the inside-outside electrically-conductive members 151 for positive electrode and for negative electrode are set in a mold for injection molding. In the present embodiment, the inside-outside electrically-conductive members 151 and the outside electrically-conductive members 153 are separate components and only the inside-outside electrically-conductive members 151 are used for the injection molding. Thus, at that time, the inside-outside electrically-conductive members 151 can be easily inserted in the terminal insertion holes 113h of the case lid member 113.

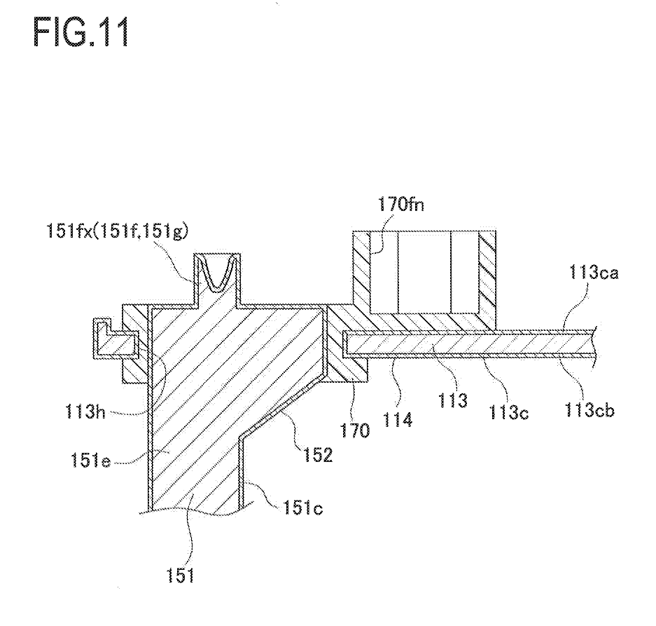

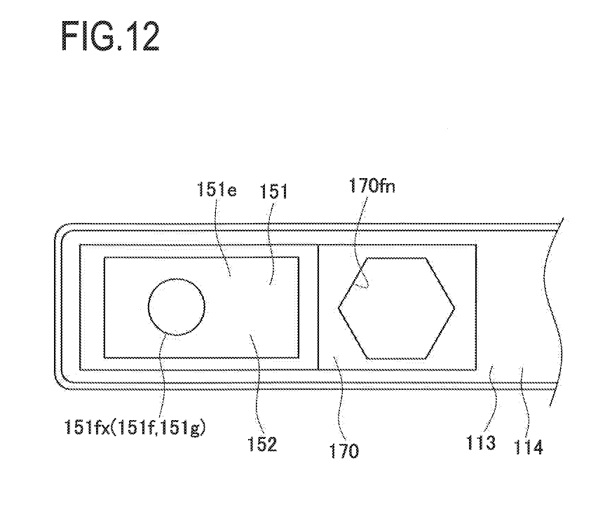

Thereafter, resin (PPS in the first embodiment) is injected, integrally molding the insulating resin members 170 whereby unitizing the case lid member 113 and the inside-outside electrically-conductive members 151 (see FIGS. 11 and 12). At that time, the coating 114 formed on the surface 113c of the case lid member 113 is chemically bonded to the resin forming the insulating resin members 170. Furthermore, each of the coating 152 formed on the surface 151c of the inside-outside electrically-conductive member 151 for positive electrode and the coating 152 formed on the surface 151c of the inside-outside electrically-conductive member 151 for negative electrode are chemically bonded to the resin forming the insulating resin members 170.

Of the case lid member 113, inside-outside electrically-conductive members 151, and insulating resin members 170 which are integrally molded, the inside-outside electrically-conductive member 151 for positive electrode is welded to the positive current collector part 121m of the electrode body 120 and also the inside-outside electrically-conductive member 151 for negative electrode is welded to the negative current collector part 131m of the electrode body 120. Then, the case body member 111 and the insulating film envelope 115 are prepared. The electrode body 120 is put in the case body member 111 through the insulating film envelope 115, and the case lid member 113 is placed to close the opening 111h of the case body member 111. By laser welding, the case body member 111 and the case lid member 113 are welded, completing the battery case 110.

In addition, the outside electrically-conductive members 153 is prepared. In the first embodiment, as described above, each of the electrically-conductive terminal members 150 and 160 is divided into two parts, i.e., the inside-outside electrically-conductive member 151 and the outside electrically-conductive member 153. Thus, this outside electrically-conductive member 153 can be easily formed (processed). Of the outside connecting portion 153g of each outside electrically-conductive member 153, the contact surface 153gc with which the out-of-battery connecting terminal such as the bus bar GT will contact is formed with the plated layer 154. To be concrete, the plated layer 154 made of tin plating is formed on the contact surface 153gc by electrolytic plating (see FIGS. 6 and 7).

The bolts 155 are then prepared and set so that the head sections 155f of the bolts 155 are fitted one in each of the recesses 170fn of the insulating resin members 170 (see FIG. 4). The outside electrically-conductive members 153 formed with the plated layers 154 are placed on the case lid member 113 (on the insulating resin members 170) so that he unprocessed insertion portions 151fx of the inside-outside electrically-conductive members 151 are inserted one through each of the fixing holes 153eh of the bases 153e and also the male screw sections 155e of the bolts 155 are inserted one through each of the screw holes 153gh of the outside connecting portions 153g.

Thereafter, the unprocessed insertion portion 151fx of each inside-outside electrically-conductive member 151 is caulked, forming the caulking portion 151g to connect the inside-outside electrically-conductive member 151 and the outside electrically-conductive member 153 to each other. Furthermore, the weld portions 151gy are formed at four spots in the circumferential direction of each caulking portion 151g by laser welding (spot welding) to join the caulking portion 151g and the base portion 153e to each other. The electrolyte 117 is poured in the battery case 110 through the liquid inlet 113e and then this inlet 113e is hermetically sealed by the seal member 112. In this way, the battery 100 is completed.

In the first embodiment, as described above, of the integrally molded case lid member 113, inside-outside electrically-conductive members 151, and insulating resin members 170, the inside-outside electrically-conductive members 151 are connected to the electrode body 120. This electrode body 120 is accommodated in the case body member 111 and the case lid member 113 is further welded to the case body member 111. Then, the bolts 155 are set in the insulating resin members 170 and the outside electrically-conductive members 153 are connected to the inside-outside electrically-conductive members 151. The above work is not limited to the above order. For example, the following order may be adopted. Of the integrally formed case lid member 113, inside-outside electrically-conductive members 151, and insulating resin members 170, the bolts 155 are first set in the insulating resin members 170, and then the outside electrically-conductive members 153 are connected to the inside-outside electrically-conductive members 151. Subsequently, the electrode body 120 is connected to the inside-outside electrically-conductive members 151. This electrode body 120 is accommodated in the case body member 111, and then the case lid member 113 is welded to the case body member 111.

### Second Embodiment

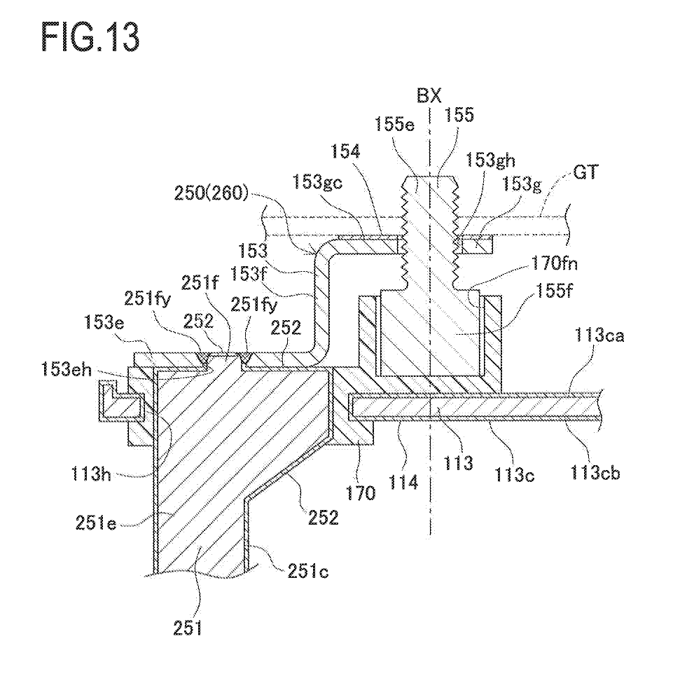

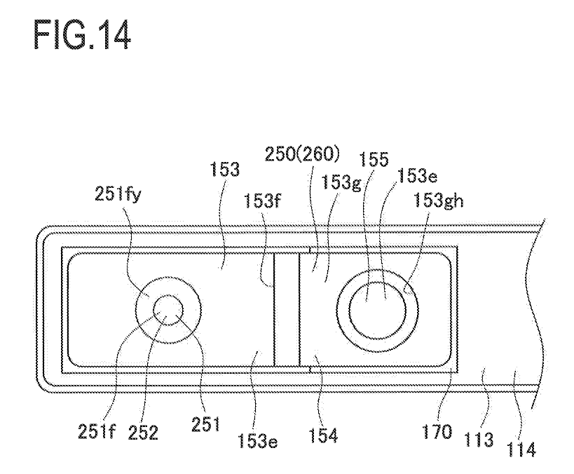

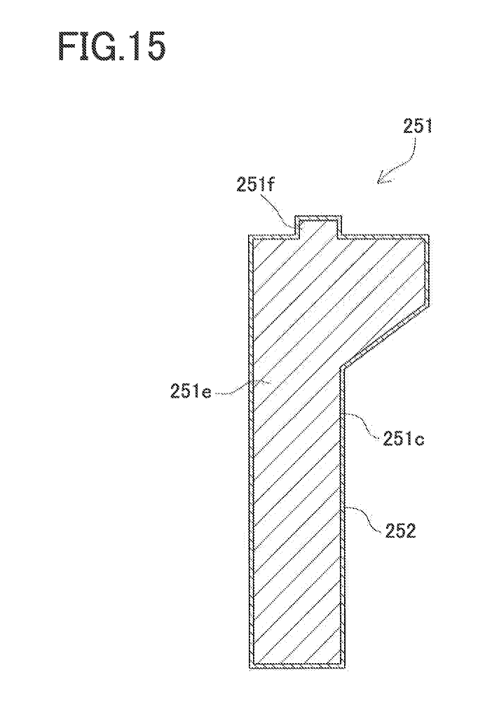

A second embodiment will be explained below. A lithium ion secondary battery (“battery”) 200 in the second embodiment differs in shape of inside-outside electrically-conductive members 251 of electrically-conductive terminal members 250 and 260 from the inside-outside electrically-conductive members 151 of the above embodiment (see FIGS. 13 to 17). Remaining parts are identical to those in the first embodiment and therefore similar or identical parts to those in the first embodiment are omitted or briefly explained.

An inside-outside electrically-conductive member 251 in the second embodiment includes a main portion 251e and an insertion portion 25 but does not include any caulked portion. These main portion 251e and insertion portion 251f are respectively identical in shape to the main portion 151e and the insertion portion 151f of the inside-outside electrically-conductive member 151 of the first embodiment. The entire surface 251c of the inside-outside electrically-conductive member 251 is formed with a coating 252 as in the first embodiment. In the second embodiment, however, a weld portion 251fy extending in annular form in plan view surrounding the insertion portion 251f is formed between the insertion portion 251f and a base portion 153e of an outside electrically-conductive member 153. Through this weld portion 251fy, the inside-outside electrically-conductive member 251 (the insertion portion 251f) and the outside electrically-conductive member 153 (the base portion 153e) are joined to each other.

The battery 200 in the second embodiment is also configured so that each of the electrically-conductive terminal members 250 and 260 includes the inside-outside electrically-conductive member 251 and the outside electrically-conductive member 153 which are separate components, and only the inside-outside electrically-conductive member 251 is integrally molded with the insulating resin member 170 and others. This can enhance the sealing performance between the electrically-conductive terminal members 250 and 260 (the inside-outside electrically-conductive members 251) and the insulating resin members 170. Separately from the shapes of the inside-outside electrically-conductive members 251 and the insulating resin members 170, the electrically-conductive terminal members 250 and 260 (the outside electrically-conductive members 153) can be designed in appropriate shapes for connection with the out-of-battery connecting terminal (the bus bar GT and so on).

In the second embodiment, the surface 251c of each inside-outside electrically-conductive member 251 is also subjected to the TRI treatment which is a chemical surface treatment, forming the coating 252 containing 1,3,5-triazine. Since the surface-treated inside-outside electrically-conductive member 251 and the insulating resin member 170 are integrally molded, the bonding strength between contact portions (joint portions) of the electrically-conductive terminal member 250 or 260 (the inside-outside electrically-conductive member 251) and the insulating resin member 170 can be increased, particularly the sealing performance therebetween can be enhanced. On the other hand, of the outside connecting portion 153g of each outside electrically-conductive member 153, the contact surface 153gc with the out-of-battery connecting terminal such as the bus bar GT is formed with the plated layer 154 for preventing oxidation. This can reduce contact resistance with the bus bar GT or the like.

In addition, the outside electrically-conductive members 153 are separate components from the inside-outside electrically-conductive members 251 and thus do not need to be subjected to the surface treatment. Accordingly, it is possible to avoid deficiencies such as peel-off of the plated layers 154 which may be caused in the surface treatment if performed after formation of the plated layer 154. It is also possible to prevent difficulties in forming the plated layers 154 or avoid an increase in resistance of the contact surfaces 153gc of the outside connecting portions 153g, which may be caused in the surface treatment if performed before formation of the plated layers 154. In this battery 200, accordingly, the sealing performance between each of the electrically-conductive terminal members 250 and 260 and corresponding one of the insulating resin members 170 can be enhanced and also the contact resistance between the electrically-conductive terminal members 250 and 260 and the bus bar GT and others can be reduced. In addition, similar or identical parts to those in the first embodiment provide the same operations and effects.

A method for producing the battery 200 in the second embodiment is described as below. Specifically, the case lid member 113 and the inside-outside electrically-conductive members 251 are prepared. These case lid member 113 and inside-outside electrically-conductive members 251 are subjected to a chemical surface treatment (i.e., TRI treatment) as in the first embodiment to enhance the bonding strength with the resin forming the insulating resin members 170. Accordingly, the coating 114 is formed on the surface 113c of the case lid member 113. Further, the coatings 252 are formed on the surfaces 251c of the inside-outside electrically-conductive members 251 for positive electrode and for negative electrode.

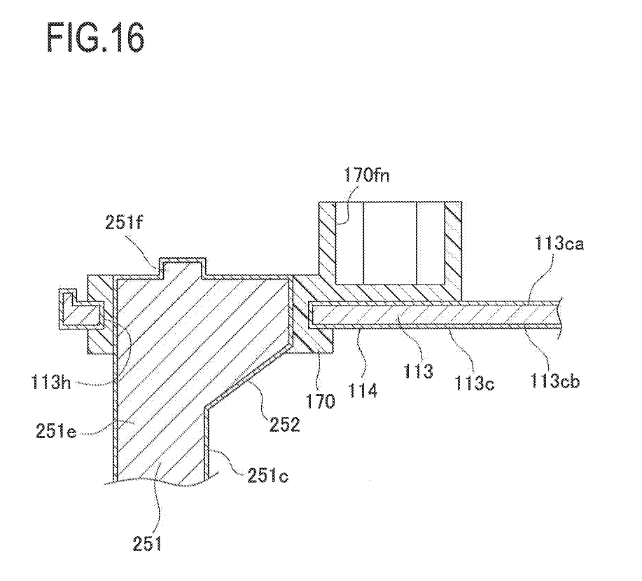

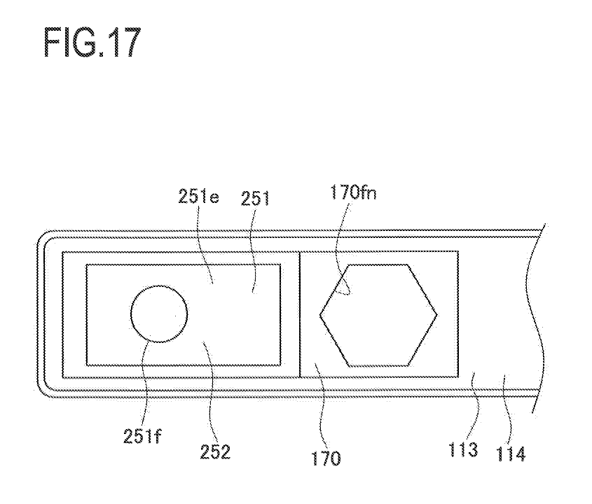

Successively, the case lid member 113 and the inside-outside electrically-conductive members 251 are set in a mold for injection molding. Resin is injected therein, integrally molding the insulating resin members 170 whereby unitizing the case lid member 113 and the inside-outside electrically-conductive members 251 (see FIGS. 16 and 17). Then, the inside-outside electrically-conductive member 251 for positive electrode is welded to the positive current collector part 121m of the electrode body 120, while the inside-outside electrically-conductive member 251 for negative electrode is welded to the negative current collector part 131m of the electrode body 120. This electrode body 120 is put in the case body member 111 through the insulating film envelope 115 and the case lid member 113 is placed to close the opening 111h of the case body member 111. By laser welding, the case body member 111 and the case lid member 113 are welded to each other.

The outside electrically-conductive members 153 identical to those in the first embodiment are prepared and the plated layers 154 are formed on the contact surfaces 153gc of the outside connecting portions 153g (see FIGS. 6 and 7) as in the first embodiment. The bolts 155 identical to those in the first embodiment are further prepared and set so that the head sections 155f of the bolts 155 are fitted one in each of the recesses 170fn of the insulating resin members 170 (see FIG. 13).

Thereafter, the outside electrically-conductive members 153 formed with the plated layers 154 are placed on the case lid member 113 (on the insulating resin members 170) so that the insertion portions 251f of the inside-outside electrically-conductive members 251 are inserted one through each of the fixing holes 153eh of the bases 153e and the male screw sections 155e of the bolts 155 are inserted one through each of the screw holes 153gh of the outside connecting portions 153g. Thereafter, the weld portions 251fy are formed one between the insertion portions 251f and the bases 153e by laser welding to the entire circumference of the insertion portion 251f in the circumferential direction, thereby joining the insertion portion 251f and the base portion 153e to each other. Through the same subsequent steps as those in the first embodiment, the battery 200 is completed.

In the second embodiment, as described above, of the integrally formed case lid member 113, inside-outside electrically-conductive members 251, and insulating resin members 170, the inside-outside electrically-conductive members 251 are connected to the electrode body 120. This electrode body 120 is set in the case body member 111 and then the case lid member 113 is welded to the case body member 111. Thereafter, the bolts 155 are set in the insulating resin members 170 and further the outside electrically-conductive members 153 are connected to the inside-outside electrically-conductive members 251. The above work is not limited to the above order. For example, the following order may be adopted. Of the integrally formed case lid member 113, inside-outside electrically-conductive members 251, and insulating resin members 170, the bolts 155 are first set in the insulating resin members 170 and then the outside electrically-conductive members 153 are connected to the inside-outside electrically-conductive members 251. Thereafter, the electrode body 120 is connected to the inside-outside electrically-conductive members 251. This electrode body 120 is accommodated in the case body member 111, and then the case lid member 113 is welded to the case body member 111.

### Third Embodiment

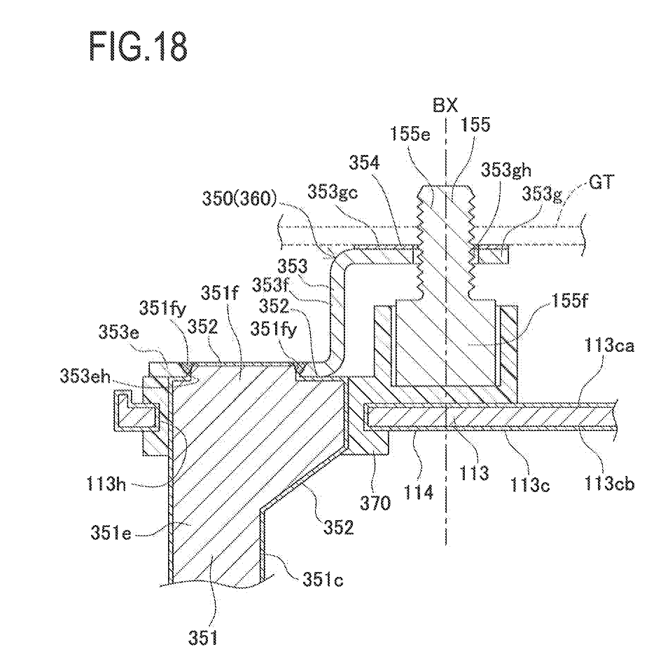

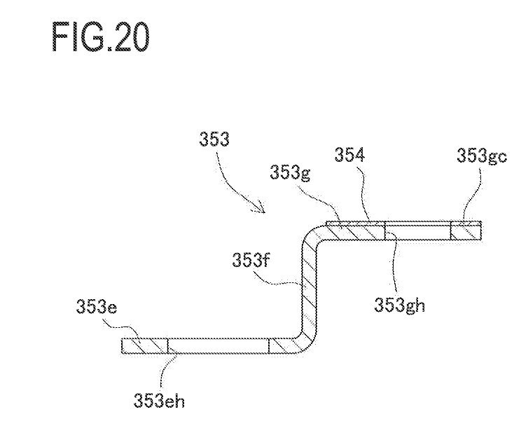

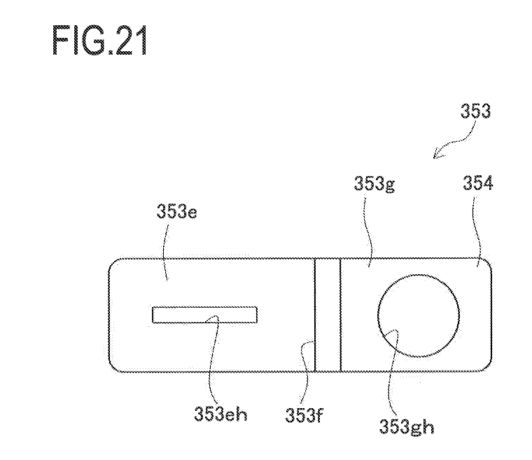

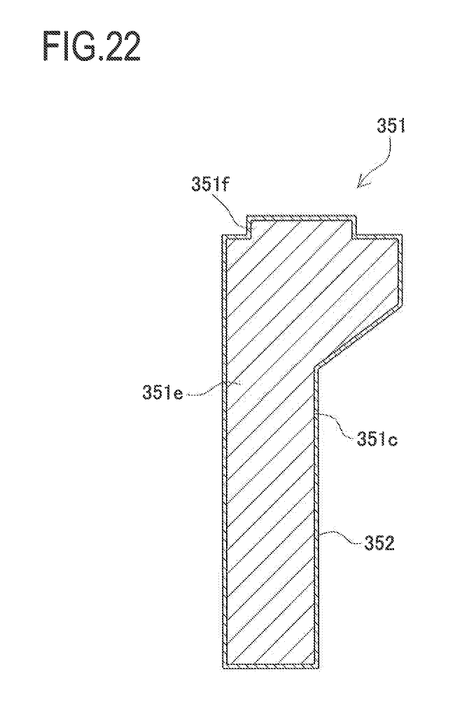

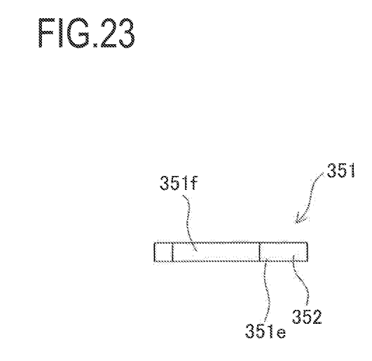

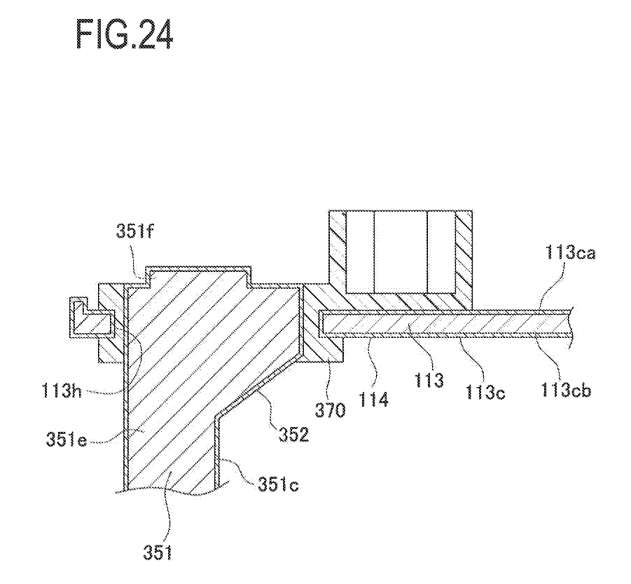

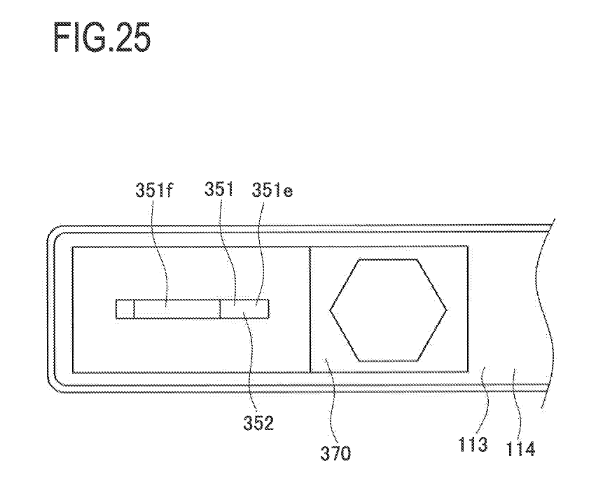

A third embodiment will be explained below. A lithium ion secondary battery (“battery”) 300 in the third embodiment differs in shape of electrically-conductive terminal members 350 and 360 (inside-outside electrically-conductive members 351 and outside electrically-conductive members 353) and insulating resin members 370 (see FIGS. 18 to 25) from the electrically-conductive terminal members 150 and 160 (inside-outside electrically-conductive members 151 and outside electrically-conductive members 153) and the insulating resin members 170 of the first embodiment. Remaining parts are identical to those in the first embodiment and therefore similar or identical parts to those in the first embodiment are omitted or briefly explained.

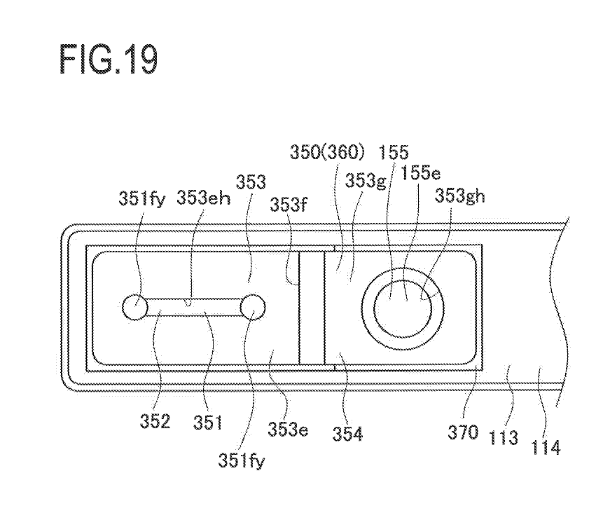

An inside-outside electrically-conductive member 351 of each of the electrically-conductive terminal members 350 and 360 in the third embodiment includes a main portion 351e and an insertion portion 351f, but does not include any caulked portion. The main portion 351e has a plate-like shape, placed in the battery case 110 and connected (welded) to the electrode body 120 and extended above the case lid member 113 through the terminal insertion hole 113h. The insertion portion 351f has a rectangular plate-like shape and is inserted in a fixing hole 351eh of a base portion 353e of the outside electrically-conductive member 353 described later. On both ends of the insertion portion 351f in the longitudinal direction (a right and left direction in FIGS. 18 and 19), weld portions 351fy are formed between the base portion 353e and the insertion portion 351f Through those weld portions 351fy, the inside-outside electrically-conductive member 351 (the insertion portion 351f) and the outside electrically-conductive member 353 (the base portion 353e) are joined to each other. The entire surface 351c of the inside-outside electrically-conductive member 351 is formed with a coating 352 as in the first embodiment.

Each of the outside electrically-conductive members 353 has a crank shape (Z-like shape) including the base portion 353e, a rising portion 353f, and an outside connecting portion 353g as in the first embodiment. In a similar way to in the first embodiment, the outside connecting portion 353g is formed with a screw hole 3530. A contact surface 353gc of the outside connecting portion 353g with which the out-of-battery connecting terminal such as the bus bar GT will contact is formed with a plated layer 354.

Although the base portion 353e is formed with the fixing hole 353eh, this hole 353eh is rectangular in plan view to match to the rectangular plate-shaped insertion portion 351f of the inside-outside electrically-conductive member 351 in the third embodiment. The insulating resin member 370 has a shape corresponding to the rectangular plate-shaped main portion 351e of the inside-outside electrically-conductive member 351 in the third embodiment.

The battery 300 in the third embodiment is also configured so that each of the electrically-conductive terminal members 350 and 360 includes the inside-outside electrically-conductive member 351 and the outside electrically-conductive member 353 which are separate components, and only the inside-outside electrically-conductive member 351 is integrally formed with the insulating resin member 370 and others. This can enhance the sealing performance between the electrically-conductive terminal members 350 and 360 (the inside-outside electrically-conductive members 351) and the insulating resin members 370. Separately from the shapes of the inside-outside electrically-conductive members 351 and the insulating resin members 370, the electrically-conductive terminal members 350 and 360 (the outside electrically-conductive members 353) can be designed in appropriate shapes for connection with the out-of-battery connecting terminal (the bus bar GT and so on).

In the third embodiment, the surface 351c of each inside-outside electrically-conductive member 351 is also subjected to the TRI treatment which is a chemical surface treatment, forming the coating 352 containing 1,3,5-triazine. Since the surface-treated inside-outside electrically-conductive member 351 and the insulating resin member 370 are integrally molded, the bonding strength between contact portions (joint portions) of the electrically-conductive terminal member 350 or 360 (the inside-outside electrically-conductive member 351) and the insulating resin member 370 can be increased, particularly the sealing performance therebetween can be enhanced. On the other hand, of the outside connecting portion 353g of each outside electrically-conductive member 353, the contact surface 353gc with the out-of-battery connecting terminal such as the bus bar GT is formed with the plated layer 354 for preventing oxidation. This can reduce contact resistance with the bus bar GT or the like.

In addition, the outside electrically-conductive members 353 are separate components from the inside-outside electrically-conductive members 351 and thus do not need to be subjected to the surface treatment. Accordingly, it is possible to avoid deficiencies such as peel-off of the plated layers 354 which may be caused in the surface treatment if performed after the plated layers 354 are formed. It is also possible to prevent difficulties in forming the plated layers 354 or avoid an increase in resistance of the contact surfaces 353gc of the outside connecting portions 353g, which may be caused in the surface treatment if performed before the plated layers 354 are formed.

Accordingly, this battery 300 can also achieve enhanced sealing performance between the electrically-conductive terminal members 350 and 360 and the insulating resin members 370 and further reduced contact resistance between the electrically-conductive terminal members 350 and 360 and the bus bar GT and others. In addition, similar or identical parts to those in the first embodiment can provide the same operations and effects. The battery 300 in the third embodiment can be produced according to the method of producing the battery 200 in the second embodiment.

### Fourth Embodiment

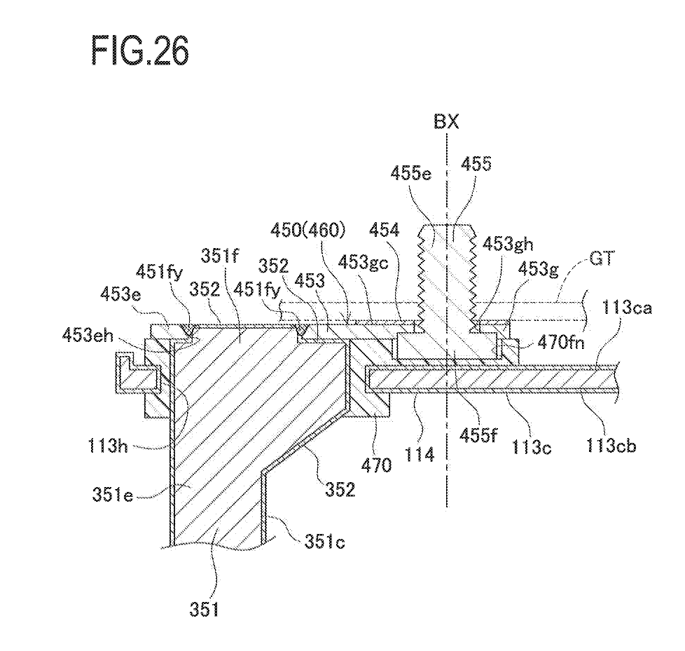

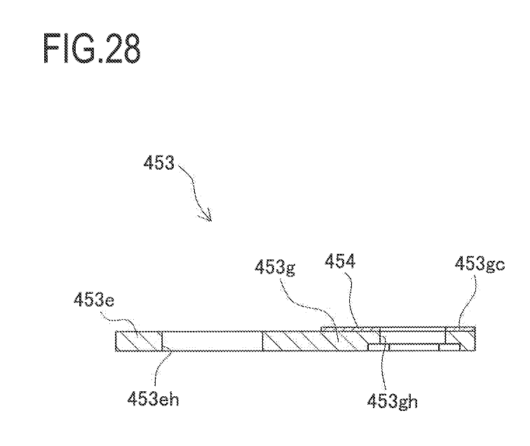

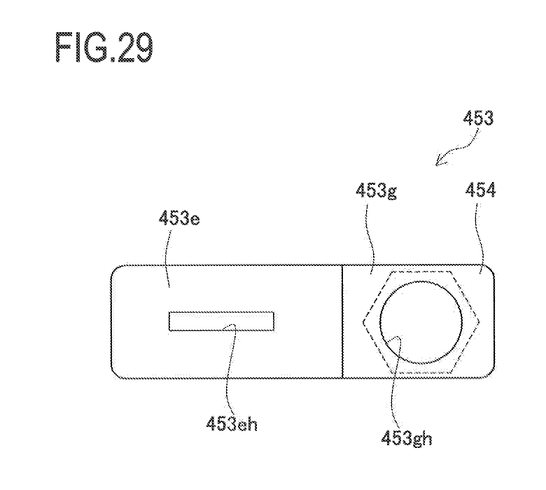

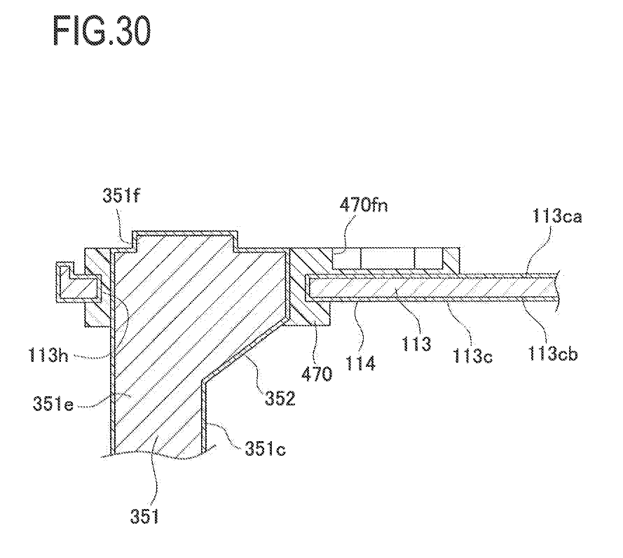

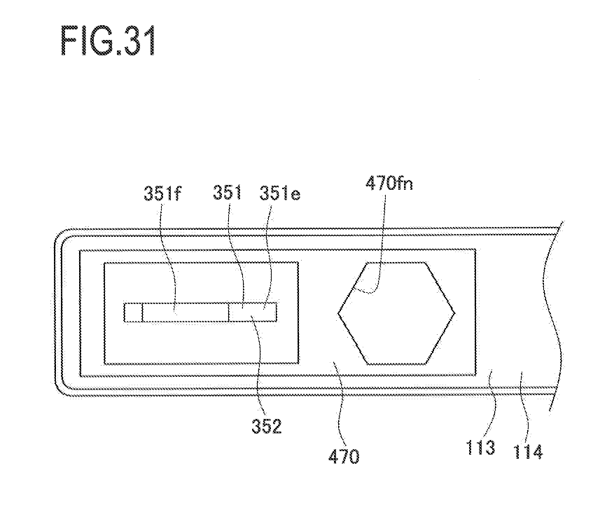

A fourth embodiment will be explained below. A lithium ion secondary battery (“battery”) 400 in the fourth embodiment differs in shape of electrically-conductive terminal members 450 and 460 (inside-outside electrically-conductive members 451 and outside electrically-conductive members 453), insulating resin members 470, and bolts 455 (see FIGS. 26 to 31) from the electrically-conductive terminal members 150 and 160 (the inside-outside electrically-conductive members 151 and the outside electrically-conductive members 153), insulating resin members 170, and bolts 155 in the first embodiment. Remaining parts are identical to those in the first embodiment and therefore similar or identical parts to those in the first embodiment are omitted or briefly explained.

The inside-outside electrically-conductive members 351 of the electrically-conductive terminal members 450 and 460 in the fourth embodiment are identical to the inside-outside electrically-conductive members 351 in the third embodiment. On the other hand, each outside electrically-conductive member 453 has a rectangular plate-like shape, different from the crank-shaped outside electrically-conductive members 153 and 353 in the above first to third embodiments. This outside electrically-conductive member 453 consists of two sections divided at the center in the longitudinal direction; one is a base portion 453e and the other is an outside connecting portion 453g.

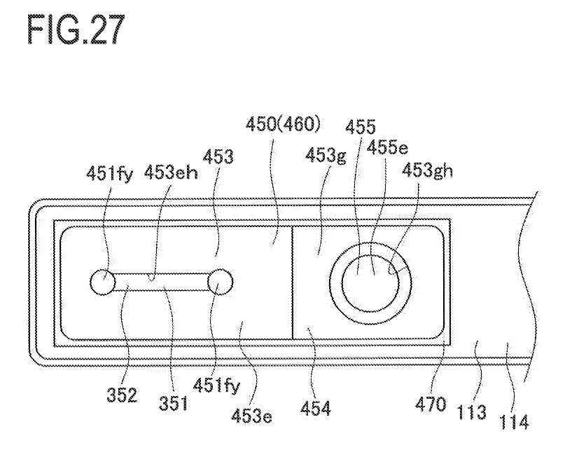

The base portion 453e is formed with a fixing hole 453eh having a rectangular shape in plan view, in which the insertion portion 351f of the inside-outside electrically-conductive member 351 is inserted. On both ends of the insertion portion 351f in the longitudinal direction (a right and left direction in FIGS. 26 and 27), weld portions 451fy are formed between the inside-outside electrically-conductive member 351 and the base portion 453e. Through those weld portions 451fy, the inside-outside electrically-conductive member 351 (the insertion portion 3510 and the outside electrically-conductive member 453 (the base portion 453e) are joined to each other. The outside connecting portion 453g is formed with a screw hole 453gh. A contact surface 453gc of the outside connecting portion 453g, with which the out-of-battery connecting terminal such as the bus bar GT will contact, is formed with a plated layer 454 as with the first embodiment.

Each of the bolts 455 in the fourth embodiment includes a male screw section 455e and a head section 455f. The male screw section 455e is identical to that of the bolt 155 in the first embodiment, but the head section 455f has a height (a length in the BX direction) smaller than the bolt 155 in the first embodiment according to the shapes of the outside electrically-conductive member 453 and the insulating resin member 470. The insulating resin member 470 in the fourth embodiment has a shape corresponding to the shapes of the inside-outside electrically-conductive member 351 and the outside electrically-conductive member 453 and others.

The battery 400 in the fourth embodiment is also configured so that each of the electrically-conductive terminal members 450 and 460 include the inside-outside electrically-conductive member 351 and the outside electrically-conductive member 453 which are separate components, and only the inside-outside electrically-conductive member 351 is integrally formed with the insulating resin member 470 and others. This can enhance the sealing performance between the electrically-conductive terminal members 450 and 460 (the inside-outside electrically-conductive members 351) and the insulating resin members 470. Separately from the shapes of the inside-outside electrically-conductive members 351 and the insulating resin members 470, the electrically-conductive terminal members 450 and 460 (the outside electrically-conductive members 453) can be designed in appropriate shapes for connection with the out-of-battery connecting terminal (a bus bar GT and so on).

In the fourth embodiment, the surface 351c of each inside-outside electrically-conductive member 351 is also subjected to the TRI treatment which is a chemical surface treatment, forming the coating 352 containing 1,3,5-triazine. Since the surface-treated inside-outside electrically-conductive member 351 and the insulating resin member 470 are integrally molded, the bonding strength between contact portions (joint portions) of the electrically-conductive terminal member 450 or 460 (the inside-outside electrically-conductive member 351) and the insulating resin member 470 can be increased, particularly the sealing performance therebetween can be enhanced. On the other hand, of the outside connecting portion 453g of each outside electrically-conductive member 453, the contact surface 453gc with the out-of-battery connecting terminal such as the bus bar GT is formed with the plated layer 454 for preventing oxidation. This can reduce contact resistance with the bus bar GT or the like.

In addition, the outside electrically-conductive members 453 are separate components from the inside-outside electrically-conductive members 351 and thus do not need to be subjected to the surface treatment. Accordingly, it is possible to avoid deficiencies such as peel-off of the plated layer 454 which may be caused in the surface treatment if performed after the plated layer 454 is formed. It is also possible to prevent difficulties in forming the plated layers 454 or avoid an increase in resistance of the contact surfaces 453gc of the outside connecting portions 453g, which may be caused in the surface treatment if performed before the plated layers 454 are formed.

Accordingly, this battery 400 can also achieve enhanced sealing performance between the electrically-conductive terminal members 450 and 460 and the insulating resin members 470 and further reduced contact resistance between the electrically-conductive terminal members 450 and 460 and the bus bar GT and others. In addition, similar or identical parts to those in the first embodiment can provide the same operations and effects. The battery 400 in the fourth embodiment can be produced according to the method of producing the batteries 200 and 300 in the second and third embodiments.

### Examples

Next, results of various tests performed to verify the effects of the invention will be explained. Example 1 of the invention uses the battery 100 of the first embodiment and Example 2 uses the battery 200 of the second embodiment. A comparative example uses a battery in which each of a terminal extending member for positive electrode and a terminal extending member for negative electrode is made of a single component (a battery in which the outside electrically-conductive member 153 and the inside-outside electrically-conductive member 151 of the battery 100 of the first embodiment is made as a single metal component). If the electrically-conductive terminal member formed with the plated layer on the outside connecting portion is subjected to the surface treatment (TRI treatment) explained in the above first and subsequent embodiments, a defect such as peel-off of the plated layer may come about. In the battery of this comparative example, therefore, only the surface treatment (TRI treatment) is performed, and no plated layer is formed.

In each of Examples 1 and 2 and Comparative example, two batteries are connected in series through a bus bar GT. Contact resistance (contact resistance in an initial stage) between the positive electrically-conductive terminal member of one battery in each example and the bus bar GT is measured. To be concrete, a 4-terminal type probe is placed in contact with one point of the positive electrically-conductive terminal member and one point of the bus bar GT. The resistance at a frequency of 1 kHz is measured by use of a resistance meter (a milliohm tester).

Under room temperature environment, the batteries connected in series in each of Examples 1 and 2 and Comparative examples are charged at a current value of 2C from SOC 0% (Battery voltage 3.0 V) to SOC 100% (Battery voltage 4.1 V), and successively discharged at a current value of 2C from SOC 100% to SOC 0%. This charge and discharge operation is assumed as one cycle and repeated by 100 cycles. Thereafter, the contact resistance (contact resistance after 100 cycles) between the positive electrically-conductive terminal member and the bus bar GT is measured again in each example. Furthermore, the above charge and discharge cycle is repeated by 100 times and the contact resistance (contact resistance after 200 cycles) between the positive electrically-conductive terminal member and the bus bar GT is measured again. These results are shown in Table 1.

TABLE 1

| | Contact Resistance (mΩ) | | |
|---|---|---|---|
| | Initial stage | After 100 cycles | After 200 cycles |
| Example 1 | 0.02 | 0.02 | 0.02 |
| Example 2 | 0.02 | 0.02 | 0.02 |
| Comparative | 0.20 | 0.57 | 0.77 |
| Example 1 | | | |

Table 1 reveals that the batteries in Examples 1 and 2 maintain all of the contact resistance in the initial stage, the contact resistance after 100 cycles, and the contact resistance after 2.00 cycles at a low value (0.02 mΩ). In contrast, the battery in Comparative example exhibits the contact resistance (0.20 mΩ) in the initial stage higher than those in Examples 1 and 2. In addition, when the charge and discharge cycle is performed by 100 times, the contact resistance is further increased (0.57 mΩ). When the charge and discharge cycle is performed by 200 times, the contact resistance is still further increased (0.77 mΩ).

In each battery of Comparative example 1, the electrically-conductive terminal member is formed of a single component. Thus, by the surface treatment applied to the electrically-conductive terminal member, the surface (contact surface) of the outside connecting portion is also formed with a coating corresponding to the coating 152 or others in the first or other embodiment. As described above, the coating formed on the electrically-conductive terminal member made of aluminum for positive electrode contains alumina and hence has a high resistance. Therefore, each battery of Comparative example 1 is conceived to have a high contact resistance between the positive electrically-conductive terminal member and the bus bar GT in the initial stage than the batteries of Examples 1 and 2. Further, each battery of Comparative example 1 is not formed with a plated layer on the surface (contact surface) of the outside connecting portion. It is conceived that as the charge and discharge cycle is repeated, the surface (contact surface) of the outside connecting portion is oxidized (aluminum is oxidized into alumina), so that the contact resistance between the positive electrically-conductive terminal member and the bus bar GT is increased.

The above results reveal that, particularly for the electrically-conductive terminal member made of metal susceptible to oxidize, the contact surface of the outside connecting portion of the electrically-conductive terminal member is preferably formed with the plated layer without being subjected to the chemical surface treatment for enhancing the bonding strength with resin. For this purpose, it is preferable that the electrically-conductive terminal member is constituted of separate components, i.e. the inside-outside electrically-conductive member and the outside electrically-conductive member, and the inside-outside electrically-conductive member is subjected to the aforementioned surface treatment, while the plated layer is formed on the contact surface of the outside connecting portion of the outside electrically-conductive member.

### Fifth Embodiment

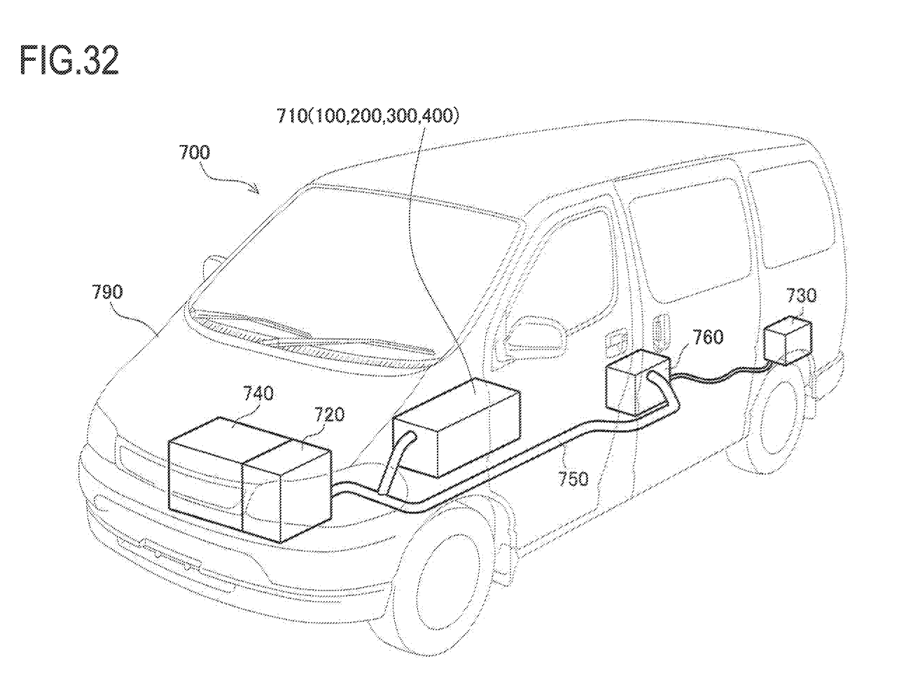

A fifth embodiment will be explained below. A hybrid car (vehicle) 700 (hereinafter, simply referred to as a car 700) in the fifth embodiment mounts the battery 100 of the aforementioned first embodiment. This car 700 uses electrical energy stored in this battery 100 for all or part of drive energy of a power source (see FIG. 32).

This car 700 is a hybrid car that mounts thereon a battery pack 710 including a plurality of the batteries 100 in combination and that is driven by use of an engine 740, a front motor 720, and a rear motor 730 in combination. To be concrete, the car 700 includes, inside a car body 790, the engine 740, the front motor 720, the rear motor 730, the battery pack 710 (the batteries 100), a cable 750, and an inverter 760. This ear 700 is configured to drive the front motor 720 and the rear motor 730 by use of the electric energy stored in the battery pack 710 (the batteries 100).

As described above, the battery 100 can provide the enhanced sealing performance between the electrically-conductive terminal members 150 and 160 and the insulating resin members 170 and also the reduced contact resistance between the electrically-conductive terminal members 150 and 160 and the out-of-battery connecting terminal (the bus bar GT and the like). Accordingly, the performance and the reliability of the car 700 mounting this battery 100 can be improved, instead of the battery 100 of the first embodiment, the battery 200, 300, or 400 of the second to fourth embodiments may be installed.

### Sixth Embodiment

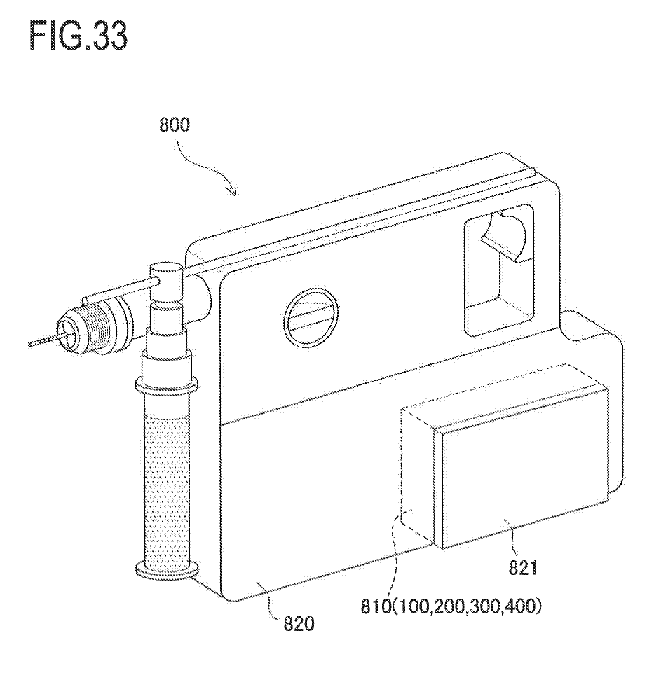

A sixth embodiment will be explained below. A hammer drill 800 of the sixth embodiment is a battery using device (see FIG. 33) mounting the battery 100 of the aforementioned first embodiment. This hammer drill 800 is configured so that a battery pack 810 including the battery 100 is housed in a bottom part 821 of a main part 820. This battery pack 810 is used as an energy source to drive the drill.

As described above, the battery 100 can achieve the enhanced sealing performance between the electrically-conductive terminal members 150 and 160 and the insulating resin members 170 and also the reduced contact resistance between the electrically-conductive terminal members 150 and 160 and the out-of-battery connecting terminal (a bus bar GT and the like). Accordingly, the performance and the reliability of the hammer drill 800 mounting this battery 100 can be improved. Instead of the battery 100 of the first embodiment, the battery 200, 300, or 400 of the second to fourth embodiments may be installed.

The present invention is explained in the above embodiments, but not limited to the above first to sixth embodiments. The invention may be embodied in other specific forms without departing from the essential characteristics thereof.

For instance, the first to fourth embodiments exemplify the rectangular battery case 110 as a “battery case”, but the invention is not limited thereto. The battery case may also be, for example, a cylindrical shape. The first to fourth embodiments show the battery 100 and others in which, of the battery case 110 including the case body member (a second case member) 111 having a box-like shape with the opening 111h and the case lid member (a first case member) 113 closing the opening 111h, the electrically-conductive terminal members 150 and 160 and others are fixedly provided in the case lid member 113. The invention is however not limited thereto. The electrically-conductive terminal members 150 and 160 and others may be fixedly provided on for example the bottom or the side surface of the case body member 111. In this case, the case body member corresponds to the aforementioned “first case member” and the case lid member corresponds to the aforementioned “second case member”.

The above first to fourth embodiments exemplify, as an “electrode body”, the wound-type electrode body 120 including the positive electrode sheet 121 and the negative electrode sheet 131, each having a strip-shape, wound together in a laminated form interposing therebetween the separators 141. The invention is not limited thereto. For instance, an electrode body may be formed in a stacked type in which a positive electrode sheet and a negative electrode sheet each having a predetermined shape (e.g., a rectangular shape) are stacked in more than two layers by interposing separators.

The above first to fourth embodiments exemplify, as a “electrically-conductive terminal member”, the positive electrically-conductive terminal member 150 and others and the negative electrically-conductive terminal member 160 and others having the same shape. Alternatively, they may have different shapes from each other.

In the above first to fourth embodiments, PPS is used as one example of the “resin” forming an “insulating resin member”, but the invention is not limited thereto. The resin may be selected from resins such as PE (polyethylene) and PP (polypropylene), epoxy, phenol, and PEEK (polyether ether ketone) or a resin made of two or more kinds of resins.

The first to fourth embodiments exemplify the TRI treatment as the chemical “surface treatment” to be applied on the surface 151c and others of the inside-outside electrically-conductive member 151 and others to enhance the bonding strength with resin, but the invention is not limited thereto. One example of this surface treatment is, as disclosed in Japanese Patent No. 3954379, that an inside-outside electrically-conductive member is immersed in an alkali aqueous solution for alkali etching, and then subjected to a neutralizing treatment, and immersed in a solution containing amine compounds. A coating formed in this way is chemically bonded to the metal forming the inside-outside electrically-conductive member and also chemically bonded to the resin forming the insulating resin member.

The first to fourth embodiments exemplify 1,3,5-triazine-2,4,6-trithiol-monosodium as the triazine compound to be used in the TRI treatment, but the invention is not limited thereto. The triazine compound to be used in the TRI treatment may be selected from 1,3,5-triazine-2,4,6-trithion, mono-, di-, or tri-alkali metal salt of 1,3,5-triazine-2,4,6-trithion, mono-, di-, or amine salt of 1,3,5-triazine-2,4,6-trithion, and others.

The first to fourth embodiments exemplify, as a “plated layer”, the plated layer 154 and others formed in only the contact surface 153gc and others of the outside connecting portion 153g and others, with which the out-of-battery connecting terminal (a bus bar GT and the like) will contact, but the invention is not thereto. The plated layer has only to be formed on at least the contact surface and for example may be formed on the entire area of the surface of the outside connecting portion. In the first to fourth embodiments, furthermore, the plated layer 154 and others made of tin plating is exemplified as a “plated layer”, but the invention is not limited thereto. The plated layer may be formed by for example nickel plating, gold plating, and others.

In the fifth embodiment, the hybrid car 700 is illustrated as one example of a vehicle mounting the battery 100 according to the present invention, but the invention is not limited thereto. A vehicle mounting a battery according to the invention may be any of electric cars, plug-in hybrid cars, hybrid railway vehicles, fork lifts, electric wheelchairs, electric bicycles, electric scooters.

In the above sixth embodiment, the battery using device mounting the battery 100 according to the invention is exemplified by the hammer drill 800, but it is not limited thereto. The battery-using device mounting the battery according to the invention may include various battery-driven household electric appliances, office equipment, and industrial equipment such as personal computers, cellular or mobile phones, battery-driven electric tools, permanent power supply systems.

1. A battery including:
a battery case formed of a first case member and a second case member joined together;
an electrode body accommodated in the battery case;
an electrically-conductive terminal member connected on one side to the electrode body in the battery case and extended on the other side out of the battery case through the first case member and to be connected to an out-of-battery connecting terminal which is a connecting terminal outside the battery to form a conductive path between the electrode body and the out-of-battery connecting terminal; and
an insulating resin member made of resin to insulate and seal between the electrically-conductive terminal member and the first case member and fix the electrically-conductive terminal member to the first case member,
wherein the electrically-conductive terminal member includes:
an inside-outside electrically-conductive member connected on one side to the electrode body in the battery case and extended on the other side out of the battery case through the first case member; and
an outside electrically-conductive member provided as a separate member from the inside-outside electrically-conductive member, the outside electrically-conductive member being placed outside the battery case and including a base portion connected to the inside-outside electrically-conductive member and an outside connecting portion to which the out-of-battery connecting terminal will be fastened, and
the insulating resin member is integrally formed with the first case member and the inside-outside electrically-conductive member.

2. The battery according to claim 1, wherein the inside-outside electrically-conductive member has a surface subjected to a chemical surface treatment to enhance bonding strength with respect to the resin,
the insulating resin member is integrally formed with the inside-outside electrically-conductive member subjected to the surface treatment, and
the outside electrically-conductive member includes a plated layer on at least a contact surface of the outside connecting portion, with which the out-of-battery connecting terminal will contact.

3. The battery according to claim 2, wherein the inside-outside electrically-conductive member includes a coating formed on the surface by the surface treatment, the coating being chemically bonded to metal forming the inside-outside electrically-conductive member and also chemically bonded to the resin forming the insulating resin member.

4. The battery according to claim 3, wherein the coating contains 1,3,5-triazine.

5. The battery according to claim 1, wherein the inside-outside electrically-conductive member and the base of the outside electrically-conductive member are joined to each other by welding.

6. The battery according to claim 1, further including a bolt placed outside the battery case to fasten the out-of-battery connecting terminal to the outside connecting portion,
wherein the outside connecting portion is formed with a screw hole,
the bolt includes:
a male screw section formed with male threads on an outer periphery and inserted in the screw hole, and
a head section having a lager diameter than the male screw section and being engageable with the outside connecting portion, and
the insulating resin member holds the head section of the bolt to disable rotation of the head section about an axis.

7. The battery according to claim 1, wherein
the outside electrically-conductive member is made of a metal plate and bent in a thickness direction to provide the base portion, the outside connecting portion, and a rising portion connecting them, arranged in a crank shape so that,
the base portion is extended along a perforated surface of the first case member through which the inside-outside electrically-conductive member passes,
the rising portion is bent at an end of the base portion and vertically extended therefrom in a direction apart from the first case member, and
the outside connecting portion is bent at an end of the rising portion and extended in parallel to the base portion.
